(19) United States
(12) Patent Application Publication
(10) Pub. No.: US 2022/0057557 A1
(43) Pub. Date: Feb. 24, 2022

(54) OPTICAL FILM WITH ADHESIVE LAYER, IMAGE DISPLAY PANEL AND IMAGE DISPLAY DEVICE

(71) Applicant: NITTO DENKO CORPORATION, Ibaraki-shi, Osaka (JP)

(72) Inventors: Masato Fujita, Ibaraki-shi (JP); Tomoyuki Kimura, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 17/414,048

(22) PCT Filed: Sep. 12, 2019
(86) PCT No.: PCT/JP2019/035860

§ 371 Date: Jun. 15, 2021

(30) Foreign Application Priority Data
Dec. 17, 2018 (JP) 2018-235448
Jul. 10, 2019 (JP) 2019-128491

(51) Int. Cl. G02B 5/30; C09J 7/38; C09J 7/10

(52) U.S. Cl. CPC G02B 5/30; C09J 7/385; C09J 2433/00; C09J 2203/326; C09J 2301/302; C09J 7/10

(57) ABSTRACT

A pressure-sensitive adhesive layer attached optical film is disclosed, including a one-side-protected polarizing film including a thin polarizer and a transparent protective film (excluding a retardation film) on one surface of the polarizer, and the pressure-sensitive adhesive layer is provided on a side of the one-side-protected polarizing film on which the transparent protective film is not provided, and the pressure-sensitive adhesive layer is formed of a pressure-sensitive adhesive composition including a (meth)acrylic polymer (A) containing 80 mass % or more of a prescribed monomer (a) as a monofunctional monomer unit and 20 mass % or more of n-butyl acrylate or 70 mass % or more of an alkoxyalkyl (meth)acrylate are contained as the prescribed monomer (a), and a silane coupling agent (B), not containing polyether compound having a polyether skeleton and a reactive silyl group.

### TECHNICAL FIELD

The present invention relates to a pressure-sensitive adhesive layer attached optical film. The pressure-sensitive adhesive layer attached optical film according to the present invention can be applied to an image display panel, and the image display panel may form an image display device such as a liquid crystal display (LCD) or an organic EL display. Further, the image display panel can be used as an image display panel with a bezel in which a bezel is provided as an outer frame on the outside of an image display panel.

### BACKGROUND ART

In an image display panel such as a liquid crystal display panel or the likes, a polarizing film is provided in its image display unit such as a liquid crystal cell due to its image-forming system. Generally, in an image display panel, at least a polarizing film is bonded to its image display unit with a pressure-sensitive adhesive layer being interposed between them.

The pressure-sensitive adhesive layer is usually formed using a pressure-sensitive adhesive containing a base polymer and a crosslinking agent. As the base polymer, an acrylic pressure-sensitive adhesive using an acrylic polymer is used. Such a pressure-sensitive adhesive is required to have re-peelability (reworkability) so that when bonded to the image display unit, the polarizing film can easily be peeled off even in a case where its bonding position is wrong or foreign matter is caught between bonding surfaces. Further, the pressure-sensitive adhesive layer is required not only to have reworkability but also to improve display non-uniformity (peripheral non-uniformity) and durability. As a pressure-sensitive adhesive composition capable of improving such properties, one obtained by adding a polyether compound having a reactive silyl group to an acrylic polymer has been proposed (Patent Document 1).

Further, a bezel (outer frame) is usually provided on the outside of the image display panel from the viewpoint of handleability etc. In recent years, bezels tend to be narrower with an emphasis on design (Patent Documents 2 and 3).

### PRIOR ART DOCUMENTS

### Patent Documents

Patent Document 1: JP-A-2010-275522

Patent Document 2: JP-A-2012-014000

Patent Document 3: JP-A-2016-004214

### SUMMARY OF THE INVENTION

### Problems to be Solved by the Invention

When the image display panel having a narrow-frame bezel is applied to an image display device such as a mobile phone, a cover glass or the like is provided as the outermost surface of the image display panel. However, when the image display panel having a narrow-frame bezel is applied to an openable image display device such as Note PC, a cover glass or the like is not usually provided as the outermost surface of the image display panel, and therefore it cannot be said that the viewing-side surface of the image display panel has sufficient strength. As a countermeasure against the above, for example, an elastic body is provided on the bezel for the purpose of preventing the image display panel from coming into direct contact with the main body of the image display device when Note PC or the like is closed after use. However, when the bezel is narrow, there is a case where it is difficult to provide such an elastic body on the bezel. Therefore, in order to use a narrow-frame bezel, a mode having an elastic intermediate layer has also been studied in which the elastic intermediate layer is provided between the edge face of the image display panel and the bezel so as to project from the viewing-side outermost surface of the image display panel.

In general, when the image display panel of Note PC or the like is opened or closed, the outer periphery of the image display panel is often touched by bare hands. On bare hands, there are fat and oil components (oleic acid etc.) of sebum. Further, after moisturizing cream, sunscreen cream, or the like is used, components of such cream may remain on bare hands. It has been found that when Note PC or the like using the image display panel with a bezel having an elastic intermediate layer is opened or closed by bare hands in such a case, the fat and oil or the cream components may directly or indirectly reach the pressure-sensitive adhesive layer used to bond the polarizing film to the image display unit through the elastic intermediate layer so that the pressure-sensitive adhesive layer swells due to absorption of the components. Particularly, in a humidified environment, the pressure-sensitive adhesive layer that has absorbed the components easily swells, which causes a problem that the pressure-sensitive adhesive layer peels off from the image display unit. However, a pressure-sensitive adhesive layer formed from the pressure-sensitive adhesive composition disclosed in Patent Document 1 cannot solve such a peeling-off problem.

Further, it has also been found that fat and oil or cream components that have reached the pressure-sensitive adhesive layer cause swelling of the pressure-sensitive adhesive layer, and further a transparent protective film of a polarizing film, to which the pressure-sensitive adhesive layer is bonded, swells due to absorption of the fat and oil or the cream components so that white crazing (crack occurrence) is caused by cracking in the transparent protective film. Such problems make it easy for fat and oil or cream components to enter the interface between the pressure-sensitive adhesive layer and the transparent protective film, and further the surface of the transparent protective film may be deformed. It has also been found that this may induce separation between the pressure-sensitive adhesive layer and the transparent protective film.

It is an object of the present invention to provide a pressure-sensitive adhesive layer attached optical film which can be applied to image display panels and the like and can prevent, even when fat and oil or cream components reach a pressure-sensitive adhesive layer thereof in a humidified environment, peeling-off of the pressure-sensitive adhesive layer and occurrence of cracking in a transparent protective film of a polarizing film included in an optical film (resistance to cracking).

It is also an object of the present invention to provide an image display panel using the pressure-sensitive adhesive layer attached optical film, further, to provide an image display device using the image display panel.

### Means for Solving the Problems

As a result of extensive studies to solve the above problems, the present inventors have found that the problems can be solved by the following the pressure-sensitive adhesive layer attached optical film and have completed the present invention.

That is, the present invention relates to a pressure-sensitive adhesive layer attached optical film, including an optical film and a pressure-sensitive adhesive layer, wherein

the optical film has a thickness of 75 μm or more,

the optical film includes a one-side-protected polarizing film including a polarizer having a thickness of 10 μm or less and a transparent protective film (excluding a retardation film) on one surface of the polarizer, and the pressure-sensitive adhesive layer is provided on a side of the one-side-protected polarizing film on which the transparent protective film is not provided,

the pressure-sensitive adhesive layer is formed of a pressure-sensitive adhesive composition containing

a (meth)acrylic polymer (A) as a base polymer which contains 80 mass % or more of at least one kind of monomer (a) selected from among an alkyl (meth)acrylate having an alkyl group containing 1 to 4 carbon atoms, an alkoxyalkyl (meth)acrylate, a fluorine-containing monomer, and acrylonitrile as a monofunctional monomer unit and 20 mass % or more of n-butyl acrylate as a monofunctional monomer unit or 70 mass % or more of an alkoxyalkyl (meth)acrylate, and

a silane coupling agent (B),

the pressure-sensitive adhesive composition containing no polyether compound having a polyether skeleton and a reactive silyl group at alkoxy alkyl least one end of the compound.

In the pressure-sensitive adhesive layer attached optical film, the pressure-sensitive adhesive layer may be provided on the one-side-protected polarizing film via retardation film.

In the pressure-sensitive adhesive layer attached optical film, the pressure-sensitive adhesive layer may be directly provided on the polarizer of the one-side-protected polarizing film.

In the pressure-sensitive adhesive layer attached optical film, the optical film preferably includes a surface-treated layer on a viewing-side outermost surface thereof.

In the pressure-sensitive adhesive layer attached optical film, the optical film preferably has a thickness of 300 μm or less.

In the pressure-sensitive adhesive layer attached optical film, the pressure-sensitive adhesive layer preferably has a thickness of 10 to 30 μm.

In the pressure-sensitive adhesive layer attached optical film, the pressure-sensitive adhesive layer is suitable even in having a degree of swelling with oleic acid of more than 130% and 190% or less.

In the pressure-sensitive adhesive layer attached optical film, only the alkyl (meth)acrylate having an alkyl group of 1 to 4 carbon atoms is used as the monomer (a), and 30 mass % or more of n-butyl acrylate is contained as the monomer unit, may be used (mode (1)).

In mode (1), mode (10) in which only n-butyl acrylate is used as the alkyl (meth)acrylate having an alkyl group of 1 to 4 carbon atoms, and 70 mass % or more of n-butyl acrylate is contained as the monomer unit, may be used.

In mode (10), mode (11) in which the alkyl (meth)acrylate having an alkyl group of 1 to 4 carbon atoms contains an alkyl (meth)acrylate having an alkyl group of 1 to 4 carbon atoms (excluding n-butyl acrylate) and n-butyl acrylate, may be used.

Further, mode (11) in which 4 to 60 mass % of the alkyl (meth)acrylate having an alkyl group of 1 to 4 carbon atoms (excluding n-butyl acrylate) and 30 mass % or more of n-butyl acrylate are contained as the monomer unit, may be used.

Further, mode (11) in which 15 to 60 mass % of the alkyl acrylate having an alkyl group of 1 to 4 carbon atoms (excluding n-butyl acrylate) and 30 mass % or more of n-butyl acrylate are contained as the monomer unit, may be used (mode (11A)).

Further, mode (11) in which 5 to 15 mass % of the alkyl methacrylate having an alkyl group of 1 to 4 carbon atoms and 70 mass % or more of n-butyl acrylate are contained as the monomer unit, may be used (mode (11B)).

In the pressure-sensitive adhesive layer attached optical film, the monomer (a) contains the alkyl (meth)acrylate having an alkyl group of 1 to 4 carbon atoms and the fluorine-containing monomer, and 30 mass % or more of the alkyl (meth)acrylate having an alkyl group of 1 to 4 carbon atoms, 25 mass % or more of the fluorine-containing monomer, and 30 mass % or more of n-butyl acrylate are contained as the monomer unit, may be used (mode (21)).

In the pressure-sensitive adhesive layer attached optical film, the monomer (a) contains the alkyl (meth)acrylate having an alkyl group of 1 to 4 carbon atoms and acrylonitrile, and 70 mass % or more of the alkyl (meth)acrylate having an alkyl group of 1 to 4 carbon atoms, 5 mass % or more of acrylonitrile, and 70 mass % or more of n-butyl acrylate are contained as the monomer unit, may be used (mode (22)).

In the pressure-sensitive adhesive layer attached optical film, the monomer (a) contains 70 mass % or more of the alkoxyalkyl (meth)acrylate, may be used (mode (23)).

In the pressure-sensitive adhesive layer attached optical film, the silane coupling agent (B) is preferably at least one selected from among an epoxy group-containing silane coupling agent (b1) and a mercapto group-containing silane coupling agent (b2). The epoxy group-containing silane coupling agent (b1) is preferably a low molecular-weight epoxy group-containing silane coupling agent (b1). And the mercapto group-containing silane coupling agent (b2) is preferably an oligomer mercapto group-containing silane coupling agent (b2).

In the pressure-sensitive adhesive layer attached optical film, wherein the pressure-sensitive adhesive composition may contain a crosslinking agent.

The present invention also relates to an image display panel including an image display unit and the pressure-sensitive adhesive layer attached optical film. The image display panel may be used in a mode of the pressure-sensitive adhesive layer attached optical film is provided on a viewing side of the image display unit via the pressure-sensitive adhesive layer of the pressure-sensitive adhesive layer attached optical film.

The present invention also relates to an image display device including the image display panel.

### Effect of the Invention

The pressure-sensitive adhesive layer attached optical film according to the present invention has an optical film having a thickness of a predetermined range or more, and therefore it is possible to prevent or prevent to some extent fat and oil or cream components from reaching or coming into contact with a pressure-sensitive adhesive layer. Further, the pressure-sensitive adhesive layer attached optical film according to the present invention uses, as the pressure-sensitive adhesive layer, one containing an acrylic polymer using a predetermined monomer in a predetermined ratio or more as a base polymer and a silane coupling agent, and therefore it is possible to prevent peeling-off of the pressure-sensitive adhesive layer from an adherend due to swelling even when fat and oil or cream components reach the pressure-sensitive adhesive layer in a humidified environment.

Further, the pressure-sensitive adhesive layer attached optical film according to the present invention uses, as a polarizing film, a one-side-protected polarizing film having a transparent protective film (excluding a retardation film) on one surface of a polarizer, and the pressure-sensitive adhesive layer is provided on the side of the one-side-protected polarizing film on which the transparent protective film is not provided, that is, the transparent protective film is not provided on the side to which the pressure-sensitive adhesive layer is bonded, and therefore crack occurrence in the transparent protective film can effectively be prevented even when the pressure-sensitive adhesive layer swells due to absorption of fat and oil or cream components in a humidified environment. Further, the polarizer is a thin polarizer having a thickness of 10 μm or less, and therefore the shrinkage of the polarizer can be kept small in a humidified environment so that separation between the polarizer and the pressure-sensitive adhesive layer is less likely to occur.

### BRIEF DESCRIPTION OF THE DRAWINGS

FIG. 1A is a partial sectional view showing an example of an image display panel with a bezel to which a pressure-sensitive adhesive layer attached optical film according to the present invention can be applied.

FIG. 1B is a top view of the example of the image display panel with a bezel shown in FIG. 1A.

FIG. 2A is a partial sectional view showing an example of an image display panel with a bezel to which a pressure-sensitive adhesive layer attached optical film according to the present invention can be applied.

FIG. 2B is a top view of the example of the image display panel with a bezel shown in FIG. 2A.

FIG. 3A is a partial sectional view showing an example of an image display panel with a bezel to which a pressure-sensitive adhesive layer attached optical film according to the present invention can be applied.

FIG. 3B is a top view of the example of the image display panel with a bezel shown in FIG. 3A.

FIG. 4 is a top view showing an example of a frame-shaped elastic intermediate layer.

FIG. 5 is a partial sectional view showing an example of an image display panel with a bezel according to a comparative example.

### MODE FOR CARRYING OUT THE INVENTION

Hereinbelow, an image display panel to which a pressure-sensitive adhesive layer attached optical film according to the present invention can be applied will be described with reference to the drawings. The following description will be made with reference to a case where the pressure-sensitive adhesive layer attached optical film is applied to an image display panel with a bezel.

As shown in the sectional view of FIG. 1A, an image display panel with a bezel to which a pressure-sensitive adhesive layer attached optical film according to the present invention includes an image display panel A having an image display unit 1 and an optical film 2 provided on the viewing side of the image display unit 1 with a pressure-sensitive adhesive layer 3 being interposed between them and an external bezel 5 provided on the outside of the edge face of the image display panel A. FIG. 1A is a partial sectional view showing an example of the image display panel with a bezel. In FIG. 1A, one of the ends of the image display panel with a bezel is shown. FIG. 1B is a top view of the image display panel with a bezel to which a pressure-sensitive adhesive layer attached optical film according to the present invention. The external bezel 5 is provided with an elastic intermediate layer 4 being interposed between the image display panel A and the external bezel 5. The elastic intermediate layer 4 is provided so as to project from a viewing-side outermost surface a of the image display panel A (optical film 2), and the external bezel 5 is provided so as not to cover the elastic intermediate layer 4. The elastic intermediate layer 4 is preferably used so as to be in contact with the edge face of the image display panel A from the viewpoints of, for example, narrowing the frame, widening the display area, preventing the entry of moisture, fat and oil, and cream components, and preventing cracking occurring from the end of the image display panel due to a reduction in the total thickness of an image display device. The external bezel 5 can be fixed to the elastic intermediate layer 4 with an adhesive.

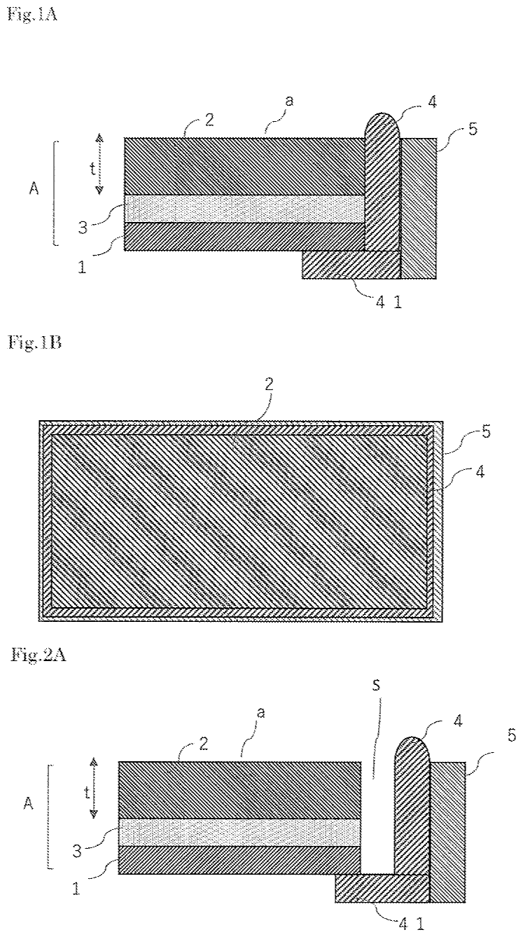

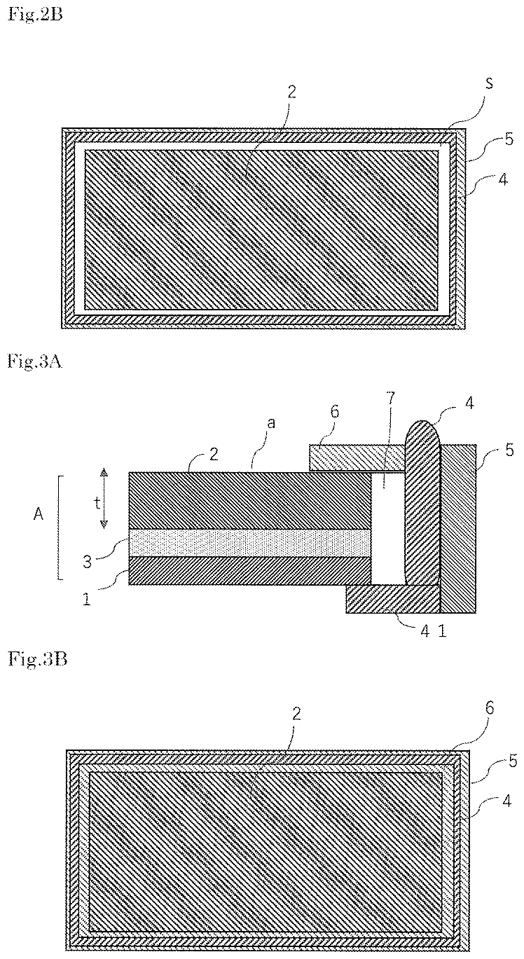

On the other hand, as shown in FIG. 2A, a space S may be provided between the edge face of the image display panel A and the elastic intermediate layer 4 from the viewpoint of facilitating a production process in which the panel is fit into a housing. FIG. 2B is a top view of the image display panel with a bezel to which a pressure-sensitive adhesive layer attached optical film according to the present invention. The space S is preferably provided to be 2000 μm or less. When the space S is provided, moisture, fat and oil, and cream components are likely to enter the space S, but peeling-off of the pressure-sensitive adhesive layer can be prevented even when the image display panel with a bezel to which a pressure-sensitive adhesive layer attached optical film according to the present invention is placed in a humidified environment. Irrespective of the presence or absence of the space S, the edge face of the optical film 2 can be coated with an acrylic resin, a urethane-based resin, a silicone-based resin, a fluorine-based resin, or the like.

Further, as shown in the sectional view of FIG. 3A, the image display panel with a bezel to which a pressure-sensitive adhesive layer attached optical film according to the present invention of the mode shown in FIG. 1A or 1B may have, at the edge face portion of the image display panel A, an internal bezel 6 provided on the outermost surface a located inner than the elastic intermediate layer 4. FIG. 3B is a top view of the image display panel with a bezel to which a pressure-sensitive adhesive layer attached optical film according to the present invention. Also in this mode, the elastic intermediate layer 4 is used so as to project from the internal bezel 6. The mode shown in FIG. 3A illustrates a case where a vacancy 7 is provided between the edge face of the image display panel A and the elastic intermediate layer 4. However, also in the mode shown in FIG. 3A, the elastic intermediate layer 4 may be used so as to be in contact with the edge face of the image display panel A. When the vacancy 7 is provided in the mode shown in FIG. 3A, accessories (e.g., camera lenses, distribution cables, dimming sensors, face recognition sensors) may be provided in the vacancy 7 so as to function via the internal bezel 6 provided above them. The internal bezel 6 can be fixed to the outermost surface a of the image display panel A and the elastic intermediate layer 4 with an adhesive.

In the image display panel with a bezel to which a pressure-sensitive adhesive layer attached optical film according to the present invention, a distance t from the viewing-side outermost surface a of the image display panel A (optical film 2) to the pressure-sensitive adhesive layer 3 is set to 75 μm or more. If the distance t is less than 75 μm, it is difficult to prevent peeling-off of the pressure-sensitive adhesive layer 3 in a humidified environment where fat and oil or cream components may come into contact with the elastic intermediate layer. The distance t is preferably 100 μm or more, more preferably 120 μm or more to prevent peeling-off of the pressure-sensitive adhesive layer 3. On the other hand, when the distance t increases (i.e., the thickness of the optical film increases), dimensional shrinkage of the optical film increases in a humidified environment so that the optical film tends to easily warp. Therefore, the distance t is preferably 300 μm or less, more preferably 250 μm or less. The distance t corresponds to the thickness of the optical film, and the thickness of the optical film in the pressure-sensitive adhesive layer attached optical film according to the present invention is preferably 75 μm or more and 300 μm or less.

Further, from the viewpoint of frame narrowing of the image display panel with a bezel, both the external bezel 5 and the elastic intermediate layer 4 are preferably small in width. The widths of the external bezel 5 and the elastic intermediate layer 4 are appropriately set depending on the size of the image display panel A, but the width of the external bezel 5 is usually 5 mm or less, preferably 0.5 to 5 mm, more preferably 0.5 to 3 mm. The width of the elastic intermediate layer 4 is 5 mm or less, preferably 0.5 to 5 mm, more preferably 0.5 to 3 mm. The internal bezel 6 is also preferably small from the viewpoint of frame narrowing. Usually, the width of the internal bezel 6 is preferably 1 to 20 mm, more preferably 1 to 15 mm. When the vacancy 7 is provided, the width thereof is preferably 1 to 20 mm, more preferably 1 to 15 mm. When the internal bezel 6 is provided, the width of the vacancy 7 is preferably 1 mm or more because even when fat and oil or cream components come into contact with the elastic intermediate layer 4, the components are less likely to reach or come into contact with the pressure-sensitive adhesive layer 3.

In the mode shown in FIG. 1A, the elastic intermediate layer 4 is used so as to project from the viewing-side outermost surface a of the image display panel A (optical film 2), and in the mode shown in FIG. 3A, the elastic intermediate layer 4 is used so as to project from the internal bezel 6. This convex part prevents the image display panel from coming into direct contact with the main body of an image display device. Usually, the height of the convex part is preferably 0.5 to 5 mm, more preferably 0.5 to 3 mm. In the top view shown in FIG. 1B and the top view shown in FIG. 3B, the elastic intermediate layer 4 is provided on the outside of the entire edge face of the image display panel A, but the present invention is effective even when the elastic intermediate layer 4 is provided at least partially.

As shown in FIG. 1A, FIG. 2A, and FIG. 3A, a holding part 41 for holding the image display panel A may be provided on the lower side of the elastic intermediate layer 4. The elastic intermediate layer 4 and the holding part 41 may integrally be formed. The width of a portion of the holding part 41 not in contact with the bottom of the elastic intermediate layer 4 is preferably 5 mm or less, preferably 3 mm or less from the viewpoint of frame narrowing and weight reduction. On the other hand, the width of the holding part 41 (the width of a portion not in contact with the bottom of the elastic intermediate layer 4) is preferably 0.1 mm or more, more preferably 0.3 mm or more from the viewpoint of holding the image display panel A. FIG. 2 illustrates a case where, on the holding part 41 of the elastic intermediate layer 4, the space S is provided between the edge face of the image display panel A and the elastic intermediate layer 4 so that the periphery of the image display panel A is held by the holding part 41. When the space S is provided, the holding part 41 is preferably designed so that the width of a portion of the holding part 41 not in contact with the bottom of the elastic intermediate layer 4 is longer than that of the space S.

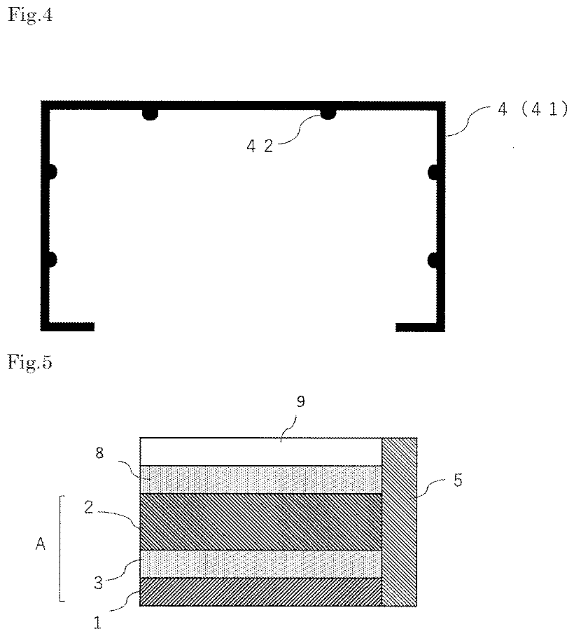

As shown in FIG. 1B, FIG. 2B, and FIG. 3B, the elastic intermediate layer 4, the external bezel 5, and the internal bezel 6 may be provided in the form of a frame. As shown in FIG. 4, when the elastic intermediate layer 4 is used in the form of a frame (FIG. 4 is a top view, and therefore a case where the holding part 41 is also provided together with the elastic intermediate layer 4 is also shown), the edge thereof may partially be omitted from the viewpoint of, for example, handleability. Further, the elastic intermediate layer 4 may have, on the inside thereof, convex parts 42 for fitting so as to be fixed to a housing. For example, in FIG. 4, on the inside of the frame, two convex parts 42 are provided on each of three edges. The number of the convex parts 42 can freely be set.

### <External Bezel, Internal Bezel>

The external bezel forms an outer frame on the outside of the edge face of the image display panel to protect the image display panel, and one usually used for image display panels can be used without particular limitation. The internal bezel protects the outermost surface at the edge face portion of the image display panel, and one usually used for image display panels can be used without particular limitation.

### <Elastic Intermediate Layer>

As described above, the elastic intermediate layer is used to prevent direct contact between the image display panel and the main body of an image display device, and is not particularly limited as long as it is formed of a material capable of cushioning an impact caused by the contact when Note PC or the like is closed. Examples of the material that can be used to form the elastic intermediate layer include rubber materials used for rubber packing, such as nitrile rubber, fluorine-containing rubber, urethane rubber, silicone rubber, ethylene propylene rubber, hydrogenated nitrile rubber, chloroprene rubber, acrylic rubber, butyl rubber, chlorosulfonated polyethylene, epichlorohydrin rubber, and natural rubber. Other examples of the material of the elastic intermediate layer include elastic plastics such as a vinyl chloride resin and a urethane resin and cushioning foams.

### <Optical Film>

Hereinbelow, the optical film used in the present invention will be described. As described above, the optical film used in the present invention includes a polarizing film. The optical film used in the present invention may be formed from a polarizing film only or may be formed as a laminate optical film obtained by combining a polarizing film and another film. The thickness of the optical film is designed so that the thickness is 75 μm or more (the same is true for a case where the optical film is a laminate optical film). On the other hand, the thickness is preferably designed to be 300 μm or less.

### <Polarizing Film>

As the polarizing film included in the optical film, a one-side-protected polarizing film is used in which a transparent protective film (excluding a retardation film) is provided on only one surface of a polarizer. In the one-side-protected polarizing film, the pressure-sensitive adhesive layer is provided on the side of the one-side-protected polarizing film on which the transparent protective film is not provided.

When the pressure-sensitive adhesive layer is directly provided on the polarizer of the one-side-protected polarizing film, the one-side-protected polarizing film and the pressure-sensitive adhesive layer form the following layer structure (1).

Layer structure (1): transparent protective film/polarizer/pressure-sensitive adhesive layer

When the pressure-sensitive adhesive layer is provided on the one-side-protected polarizing film with a retardation film being interposed between them, the one-side-protected polarizing film and the pressure-sensitive adhesive layer form the following layer structure (2).

Layer structure (2): transparent protective film/polarizer/retardation film/pressure-sensitive adhesive layer

The polarizer is not particularly limited but various kinds of polarizers may be used. Examples of the polarizer include a film obtained by uniaxial stretching after a dichromatic substance, such as iodine and dichroic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable.

As the polarizer, a thin polarizer having a thickness of 10 μm or less is preferably used. Particularly, a thin polarizer is preferably used in the one-side-protected polarizing film. The thickness of the polarizer is preferably 3 μm or more to prevent peeling-off of the pressure-sensitive adhesive layer caused by fat and oil or cream components. Further, from the viewpoint of preventing dimensional shrinkage in a humidified environment, the thickness of the polarizer is preferably 10 μm or less. Such a thin polarizer having a thickness of 3 to 10 μm is preferred in that there is little variation in thickness, visibility is excellent, durability is excellent due to little dimensional change, and the thickness of the polarizing film can also be reduced.

The polarizer is not particularly limited but various kinds of polarizers may be used. Examples of the polarizer include a film obtained by uniaxial stretching after a dichromatic substance, such as iodine and dichroic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable. Thickness of these polarizers is not particularly limited but is generally about 30 μm or less.

The material of the transparent protective film is preferably a cellulose resin or a (meth)acrylic resin. As the (meth)acrylic resin, a (meth)acrylic resin having a lactone ring structure is preferably used. Examples of the (meth)acrylic resin having a lactone ring structure include (meth)acrylic resins having a lactone ring structure disclosed in JP-A-2000-230016, JP-A-2001-151814, JP-A-2002-120326, JP-A-2002-254544, and JP-A-2005-146084, etc. Particularly, the cellulose resin is more preferred than the (meth)acrylic resin in that polarizer cracking is effectively prevented which is a problem for a one-side-protected polarizing film in which a transparent protective film is provided on only one surface of a polarizer. Usually, the thickness of the transparent protective film is preferably 10 to 100 μm, more preferably 20 to 50 μm, even more preferably 30 to 50 μm. Particularly, when a cellulose resin is used as the material of the transparent protective film, the thickness is preferably controlled to be 100 μm or less to prevent dimensional shrinkage in a humidified environment.

The transparent protective film does not include a retardation film. The transparent protective film not included in a retardation film is “optically isotropic”, and “optically isotropic” means that an in-plane retardation Re(550) is 0 nm to 10 nm and a thickness direction retardation Rth(550) is −10 nm to +10 nm.

### Definitions of Terms and Symbols

Terms and symbols used herein are defined as follows.

(1) Refractive Indexes (Nx, Ny, Nz)

“nx” represents a refractive index in a direction in which an in-plane refractive index is maximum (i.e., in a slow axis direction), “ny” represents a refractive index in a direction perpendicular to the slow axis in the plane (i.e., in a fast axis direction), and “nz” is a refractive index in a thickness direction.

(2) In-Plane Retardation (Re)

“Re(λ)” represents an in-plane retardation of a film measured at 23° C. with light having a wavelength of A nm. For example, “Re(450)” represents an in-plane retardation of a film measured at 23° C. with light having a wavelength of 450 nm. Re(A) is determined from the formula: Re=(nx−ny)×d, wherein d represents the thickness (nm) of a film.

(3) Thickness Direction Retardation (Rth)

“Rth(λ)” represents a thickness direction retardation of a film measured at 23° C. with light having a wavelength of 550 nm. For example, “Rth(450)” represents a thickness direction retardation of a film measured at 23° C. with light having a wavelength of 450 nm. Rth(λ) is determined from the formula: Rth=(nx−nz)×d, wherein d represents the thickness (nm) of a film.

The adhesive used to bond the polarizer and the transparent protective film is not particularly limited as long as such adhesive is optically transparent, and various aqueous, solvent-based, hot melt-based, radical curable, or cationic curable types are used. However, aqueous adhesives or radical curable type adhesives are preferred.

### <Surface-Treated Layer»

On the outermost surface of the optical film, a surface-treated layer may be provided. As the surface-treated layer, a hard coat layer, an antiglare layer, an antireflective layer, an anti-sticking layer, and the like can be provided. The surface-treated layer can be provided on a transparent protective film used for the polarizing film or can be separately provided from the transparent protective film. As a base material separately provided, the same one as the transparent protective film may be used. When provided separately, the surface-treated layer can be bonded to the polarizing film with a conventionally-known pressure-sensitive adhesive layer or the like. The surface-treated layer is provided on the opposite side from the side of the polarizing film in the optical film on which the pressure-sensitive adhesive layer is provided.

As a material for forming the hard coat layer provided as the surface-treated layer, for example, a thermoplastic resin or a material which is cured by heat or radiation can be used. Examples of such materials include thermosetting resins and radiation-curable resins such as ultraviolet curable resins and electron beam curable resins. Among them, ultraviolet curable resins are preferred, which can efficiently form a cured resin layer by a simple processing operation at the time of curing by ultraviolet radiation. Examples of such curable resins include a variety of resins such as polyester-based resins, acrylic resins, urethane-based resins, amide-based resins, silicone-based resins, epoxy-based resins, and melamine-based resins, including monomers, oligomers, and polymers thereof. In particular, radiation curable resins, specifically ultraviolet curable resins are preferred, because of high processing speed and less thermal damage to the base material. The ultraviolet curable resin to be preferably used is, for example, one having an ultraviolet-polymerizable functional group, particularly one containing an acrylic monomer or oligomer component having 2 or more, particularly 3 to 6 of such functional groups. In addition, a photopolymerization initiator is blended in the ultraviolet curable resin.

Further, as the surface-treated layer, an antiglare treatment layer or an antireflection layer can be provided for the purpose of improving visibility. An antiglare layer and an antireflection layer may be provided on the hard coat layer. The constituent material of the antiglare treatment layer is not particularly limited, and for example, a radiation curable resin, a thermosetting resin, a thermoplastic resin, or the like can be used. As the antireflection layer, titanium oxide, zirconium oxide, silicon oxide, magnesium fluoride or the like is used. Multiple layers can be provided for the antireflection layer. Other examples of the surface-treated layer include an anti-sticking layer and the like.

### <Other Layers>

In the optical film (laminate optical film), a retardation film (including a half wavelength plate, a quarter wavelength plate, or the like), a viewing angle compensating film, and the like can be laminated in addition to the layers described above. Further, the polarizing film and the other optical layers may be provided with an anchor layer or an easily-adhesive layer or may be subjected to various treatments for easy adhesion such as corona treatment and plasma treatment.

As shown in the layer structure (2), the pressure-sensitive adhesive layer can be provided on the one-side-protected polarizing film with a retardation film being interposed between them. Examples of the retardation film to be used include a birefringent film obtained by subjecting a polymer material to uniaxial or biaxial stretching, a liquid crystal polymer alignment film, and a film supporting a liquid crystal polymer alignment layer. These retardation films may be used singly or in combination of two or more of them.

When the pressure-sensitive adhesive layer attached optical film is applied to the image display panel for PCs, the retardation film is preferably provided between the polarizer and the image display unit from the viewpoints of viewing angle compensation, low reflectance, etc., and is therefore differentiated from the above-described transparent protective film. As the retardation film, one having a thickness of 4 to 150 μm can usually be used. However, it is advantageous that the thickness is made as small as possible within an appropriate range to prevent peeling-off of the pressure-sensitive adhesive layer in a humidified environment and to prevent cracking of the retardation film. For example, the thickness (total) of the retardation film is preferably 2 to 25 μm, more preferably 4 to 24 μm.

### <Pressure-Sensitive Adhesive Layer>

Hereinbelow, the pressure-sensitive adhesive layer the pressure-sensitive adhesive layer attached optical film will be described. The pressure-sensitive adhesive layer is formed of a pressure-sensitive adhesive composition containing, as a base polymer, a (meth)acrylic polymer (A) containing 80 mass % or more of at least one kind of monomer (a) selected from among an alkyl (meth)acrylate having an alkyl group of 1 to 4 carbon atoms, an alkoxyalkyl (meth)acrylate, a fluorine-containing monomer, and acrylonitrile as a monofunctional monomer unit and 20 mass % or more of n-butyl acrylate as a monomer unit or 70 mass % or more of an alkoxyalkyl (meth)acrylate. The monofunctional monomer unit is the unit of a compound constituting the (meth)acrylic polymer (A) and having one unsaturated double bond such as a (meth)acryloyl group or a vinyl group. The (meth)acrylic polymer (A) includes a partially polymerized product of a monomer component containing the alkyl (meth)acrylate (a) and/or a (meth)acrylic polymer obtained from the monomer component. It is to be noted that (meth)acrylate refers to acrylate and/or methacrylate, and “(meth)” is used in the same meaning in the present invention.

The main skeleton of the (meth)acrylic polymer (A) is formed of at least one kind of monomer (a) selected from among an alkyl (meth)acrylate having an alkyl group of 1 to 4 carbon atoms, an alkoxyalkyl (meth)acrylate, a fluorine-containing monomer, and acrylonitrile. The mass ratio of the monomer (a) is 80 mass % or more of the total mass of all the monomers (monofunctional monomers 100 mass %, the same applies hereinafter) constituting the (meth)acrylic polymer (A) as the monomer unit, and the use of the (meth)acrylic polymer (A) containing the monomer (a) in such a ratio makes it possible to prevent peeling-off of the pressure-sensitive adhesive layer because of fat and oil or cream components.

Examples of the alkyl group in the alkyl (meth)acrylate having an alkyl group of 1 to 4 carbon atoms include linear or branched alkyl groups such as a methyl group, an ethyl group, a propyl group, an isopropyl group, an n-butyl group, an isobutyl group, and a t-butyl group.

As the alkyl (meth)acrylate having an alkyl group of 1 to 4 carbon atoms, an alkyl (meth)acrylate having an alkyl group containing 4 carbon atoms is preferred, and n-butyl acrylate is particularly preferred. n-butyl acrylate is an essential monomer unit constituting the (meth)acrylic polymer (A), and only n-butyl acrylate may be used as the monomer (a). The mass ratio of n-butyl acrylate is 20 mass % or more of the total mass of all the monomers (monofunctional monomers 100 mass %) constituting the (meth)acrylic polymer (A) as the monomer unit, and the use of the (meth)acrylic polymer (A) containing n-butyl acrylate in such a ratio makes it possible to prevent peeling-off of the pressure-sensitive adhesive layer because of fat and oil or cream components. The mass ratio of n-butyl acrylate to be used may be 30 mass % or more, 40 mass % or more, 50 mass % or more, further 60 mass % or more, further 70 mass % or more, further 80 mass % or more, or further 90 mass % or more.

The alkoxyalkyl (meth)acrylate is not particularly limited, but the alkoxyalkyl group is preferably an alkoxyalkyl group having 3 to 25 carbon atoms in total. Examples of the alkoxyalkyl (meth)acrylate include 2-methoxyethyl (meth)acrylate, 2-ethoxyethyl (meth)acrylate, 3-methoxypropyl (meth) acrylate, 3-ethoxypropyl (meth)acrylate, 4-methoxybutyl (meth)acrylate, and ethoxybutyl (meth)acrylate. Another example of the alkoxyalkyl (meth)acrylate is alkoxypolyalkyleneglycol such as methoxytriethyleneglycol (meth)acrylate. As a commercialized product thereof, for example, methoxypolyethyleneglycol (meth)acrylate (Bisomer MPE400A manufactured by OSAKA ORGANIC CHEMICAL INDUSTRY LTD.) can be mentioned.

Examples of the fluorine-containing monomer include, but are not limited to, those having a radical polymerizable C—C double bond such as a (meth)acryloyl group or a vinyl group and an alkyl group having 3 to 10 carbon atoms substituted by at least one fluorine atom. Examples of such a fluorine-containing monomer include 2,2,2-trifluoroethylacrylate, 2-(perfluorohexyl)ethyl acrylate, 2,2,3,3,3-pentafluoropropyl acrylate, 2-(perfluorobutyl)ethyl acrylate, 3-perfluorobutyl-2-hydroxypropyl acrylate, 3-perfluorohexyl-2-hydroxypropyl acrylate, 3-(perfluoro-3-methylbutyl)-2-hydroxypropyl acrylate, 1H,1H,3H-tetrafluoropropyl acrylate, 1H,1H,5H-octafluoropentyl acrylate, 1H,1H,7H-dodecafluoroheptyl acrylate, 1H-1-(trifluoromethyl)trifluoroethyl acrylate, 1H,1H,3H-hexafluorobutyl acrylate, and 1,2,2,2-tetrafluoro-1-(trifluoromethyl)ethyl acrylate. It is to be noted that the above-described fluorine-containing monomers having a hydroxy group are not regarded as hydroxyl group-containing monomers that will be described later.

As the monomer (a), at least one selected from among an alkyl (meth)acrylate having an alkyl group of 1 to 4 carbon atoms, an alkoxyalkyl (meth)acrylate, a fluorine-containing monomer, and acrylonitrile is used, but only the alkyl (meth)acrylate having an alkyl group of 1 to 4 carbon atoms may be used as the monomer (a) (mode (1)). In the case of the mode (1), 30 mass % or more of n-butyl acrylate is preferably contained as the monomer unit. The mode (1) is preferred from the viewpoint of achieving resistance to heating and resistance to heat and humidity.

As the mode (1) using only the alkyl (meth)acrylate having an alkyl group of 1 to 4 carbon atoms as the monomer (a), for example, a mode (10) using only n-butyl acrylate as the monomer (a) may be employed. In the case of the mode (10), 70 mass % or more of n-butyl acrylate is preferably contained as the monomer unit. In this case, depending on the type of copolymerizable monomer, crosslinking agent, or the like, n-butyl acrylate as the monomer unit may be used in a ratio of 80 mass % or more, 90 mass % or more, or further 95 mass % or more. The mode (10) is preferred from the viewpoint of achieving resistance to heating and resistance to heat and humidity.

As the mode (1) using only the alkyl (meth)acrylate having an alkyl group of 1 to 4 carbon atoms as the monomer (a), for example, a mode (11) using the alkyl (meth)acrylate having an alkyl group of 1 to 4 carbon atoms except for n-butyl acrylate in combination with n-butyl acrylate may be employed. Preferred examples of the alkyl (meth)acrylate having an alkyl group of 1 to 4 carbon atoms except for n-butyl acrylate include an alkyl (meth)acrylate having an alkyl group containing 1 to 3 carbon atoms and t-butyl acrylate. Preferred examples of the alkyl (meth)acrylate having an alkyl group containing 1 to 3 carbon atoms include alkyl (meth)acrylates having an alkyl group containing 1 to 2 carbon atoms, such as methyl acrylate, methyl methacrylate, and ethyl acrylate. That is, the mode (11) using n-butyl acrylate and the monomer (a) except for n-butyl acrylate in combination preferably uses an alkyl (meth)acrylate having an alkyl group containing 1 to 3 carbon atoms or t-butyl acrylate as the monomer (a) and n-butyl acrylate. The mode (11) is preferred from the viewpoints of resistance to oil, workability, handling, and resistance to cracking.

In the case of the combination use mode (11), the total mass ratio of n-butyl acrylate and the alkyl (meth)acrylate having an alkyl group containing 1 to 3 carbon atoms is preferably adjusted to 80 mass % or more by adjusting the mass ratio of the alkyl (meth)acrylate having an alkyl group containing 1 to 3 carbon atoms to preferably 4 to 60 mass %, more preferably 4 to 50 mass %, even more preferably 10 to 40 mass % and, on the other hand, adjusting the mass ratio of n-butyl acrylate to preferably 30 mass % or more, more preferably 30 to 96 mass % even more preferably 40 to 90 mass %.

Further, in the case of a mode (11A) according to the combination use mode (11), in which an alkyl acrylate is used as the alkyl (meth)acrylate having an alkyl group of 1 to 4 carbon atoms (excluding n-butyl acrylate), the total mass ratio of the alkyl acrylate and n-butyl acrylate is preferably adjusted to 80 mass % or more by adjusting the mass ratio of the alkyl acrylate to preferably 15 to 60 mass %, more preferably 15 to 45 mass %, even more preferably 20 to 40 mass %, and, on the other hand, adjusting the mass ratio of n-butyl acrylate to preferably 30 mass % or more, more preferably 40 to 85 mass %, even more preferably 40 to 75 mass %. The mode (11A) is preferred from the viewpoints of resistance to oil, workability, handling, and resistance to cracking.

Further, in the case of a mode (11B) according to the combination use mode (11), in which an alkyl methacrylate is used as the alkyl (meth)acrylate having an alkyl group of 1 to 4 carbon atoms (excluding n-butyl acrylate), the total mass ratio of the alkyl methacrylate and n-butyl acrylate is preferably adjusted to 80 mass % or more by adjusting the mass ratio of the alkyl methacrylate to preferably 5 to 15 mass %, more preferably 5 to 10 mass % and, on the other hand, adjusting the mass ratio of n-butyl acrylate to preferably 70 mass % or more, more preferably 70 to 90 mass %. The mode (11B) is preferred from the viewpoints of workability, handling, and resistance to cracking.

Further, a mode (21) may be employed in which, for example, the alkyl (meth)acrylate having an alkyl group of 1 to 4 carbon atoms and the fluorine-containing monomer are used in combination as the monomer (a). In the case of the combination use mode (21), the total mass ratio of the alkyl (meth)acrylate having an alkyl group of 1 to 4 carbon atoms and the fluorine-containing monomer is preferably adjusted to 80 mass % or more by adjusting the mass ratio of the alkyl (meth)acrylate having an alkyl group of 1 to 4 carbon atoms to preferably 30 mass % or more, more preferably 30 to 55 mass % and adjusting the mass ratio of the fluorine-containing monomer to preferably 25 mass % or more, more preferably 25 to 50 mass %, and the mass ratio of n-butyl acrylate is preferably adjusted to 30 mass % or more, more preferably 30 to 55 mass %. The mode (21) is preferred from the viewpoint of resistance to oil.

Further, a mode (22) may be employed in which, for example, the alkyl (meth)acrylate having an alkyl group of 1 to 4 carbon atoms and acrylonitrile are used in combination as the monomer (a). In the case of the combination use mode (22), the total mass ratio of the alkyl (meth)acrylate having an alkyl group of 1 to 4 carbon atoms and acrylonitrile is preferably adjusted to 80 mass % or more by adjusting the mass ratio of the alkyl (meth)acrylate having an alkyl group of 1 to 4 carbon atoms to preferably 70 mass % or more, more preferably 70 to 85 mass % and adjusting the mass ratio of acrylonitrile to preferably 5 mass % or more, more preferably 10 to 20 mass %, and the mass ratio of n-butyl acrylate is preferably adjusted to 70 mass % or more, more preferably 70 to 85 mass %. The mode (22) is preferred from the viewpoint of resistance to heating.

Further, a mode (23) may be employed in which, for example, 70 mass % or more of the alkoxyalkyl (meth)acrylate is used as the monomer (a). In the case of the mode (23), the alkoxyalkyl (meth)acrylate may be used in a mass ratio of 80 mass % or more, further 90 mass % or more, or further 100 mass %. In the mode (23), the alkyl (meth)acrylate having an alkyl group of 1 to 4 carbon atoms may be used in combination with the alkoxyalkyl (meth)acrylate. The total mass ratio of the alkyl (meth)acrylate having an alkyl group of 1 to 4 carbon atoms and the alkoxyalkyl (meth)acrylate is preferably adjusted to 80 mass % or more by adjusting the mass ratio of the alkyl (meth)acrylate having an alkyl group of 1 to 4 carbon atoms to preferably 20 mass % or more and adjusting the mass ratio of the alkoxyalkyl (meth)acrylate to preferably 70 mass % or more, more preferably 70 to 99 mass %, and the mass ratio of n-butyl acrylate is preferably adjusted to 20 mass % or more. The mode (23) is preferred from the viewpoints of high pressure-sensitive adhesive force and resistance to oil.

It is to be noted that also in the combination use modes (21) to (23), a monomer other than n-butyl acrylate may be used in combination with the alkyl (meth)acrylate having an alkyl group of 1 to 4 carbon atoms as long as the above-described range of the mass ratio of n-butyl acrylate or the alkoxyalkyl (meth)acrylate is satisfied. Particularly, as the mode (21), a mode may preferably be employed in which the alkyl acrylate having an alkyl group containing 1 to 3 carbon atoms is used as the alkyl (meth)acrylate having an alkyl group of 1 to 4 carbon atoms in addition to n-butyl acrylate.

It is to be noted that for the purpose of improving adhesiveness and heat resistance, the (meth)acrylic polymer (A) may contain, in addition to a monomer unit as the monomer (a), one or more kinds of copolymerizable monomers introduced by copolymerization which have a polymerizable functional group having an unsaturated double bond, such as a (meth)acryloyl group or a vinyl group. The mass ratio of the copolymerizable monomer is 20 mass % or less.

However, an increase in the polymerization ratio of an alkyl (meth)acrylate having an alkyl group containing 5 or more carbon atoms is not preferred from the viewpoint of preventing peeling-off of the pressure-sensitive adhesive. Therefore, the polymerization ratio of an alkyl (meth)acrylate having an alkyl group containing 5 or more carbon atoms is 20 mass % or less, preferably 15 mass % or less, more preferably 10 mass % or less, even more preferably 5 mass % or less, even more preferably 3 mass % or less, even more preferably 1 mass % or less, and non-use is most preferred.

As the copolymerizable monomer, for example, an aromatic ring-containing (meth)acrylate may be used. The aromatic ring-containing (meth)acrylate is a compound containing an aromatic ring structure in the structure thereof and a (meth)acryloyl group. Examples of the aromatic ring include a benzene ring, a naphthalene ring, and a biphenyl ring.

Specific examples of the aromatic ring-containing (meth)acrylate include: benzene ring-containing (meth)acrylates such as benzyl (meth)acrylate, phenyl (meth)acrylate, o-phenylphenol (meth)acrylate, phenoxy (meth) acrylate, phenoxyethyl (meth) acrylate, phenoxypropyl (meth)acrylate, phenoxydiethyleneglycol (meth)acrylate, ethylene oxide-modified nonylphenol (meth)acrylate, ethylene oxide-modified cresol (meth)acrylate, phenol ethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth) acrylate; naphthalene ring-containing (meth)acrylates such as hydroxyethylated β-naphthol acrylate, 2-naphthoethyl (meth) acrylate, 2-naphthoxyethyl acrylate, and 2-(4-methoxy-1-naphthoxy)ethyl (meth)acrylate; and biphenyl ring-containing (meth)acrylates such as biphenyl (meth)acrylate and the like.

As the aromatic ring-containing (meth)acrylate, benzyl (meth)acrylate and phenoxyethyl (meth)acrylate are preferred, and phenoxyethyl (meth)acrylate is particularly preferred from the viewpoints of pressure-sensitive adhesive properties and durability.

The mass ratio of the aromatic ring-containing (meth)acrylate is 20 mass % or less, preferably 3 to 18 mass %, more preferably 5 to 16 mass %, even more preferably 10 to 14 mass %. A mass ratio of 3 mass % or more of the aromatic ring-containing (meth)acrylate is preferred from the viewpoint of preventing display unevenness.

Examples of the copolymerizable monomer include functional group-containing monomers such as a hydroxyl group-containing monomer, a carboxyl group-containing monomer, and an amide group-containing monomer.

The hydroxyl group-containing monomer is a compound containing a hydroxyl group and a polymerizable unsaturated double bond, such as a (meth)acryloyl group or a vinyl group, in the structure thereof. Specific examples of the hydroxyl group-containing monomer include: hydroxy alkyl (meth)acrylates such as 2-hydroxyethyl (meth)acrylate, 3-hydroxypropyl (meth) acrylate, 4-hydroxybutyl (meth)acrylate, 6-hydroxyhexyl (meth)acrylate, 8-hydroxyoctyl (meth) acrylate, 10-hydroxydecyl (meth)acrylate, and 12-hydroxylauryl (meth)acrylate; and (4-hydroxymethylcyclohexyl)-methyl acrylate. Among these hydroxyl group-containing monomers, from the viewpoint of durability, 2-hydroxyethyl (meth)acrylate and 4-hydroxybutyl (meth)acrylate are preferred, and 4-hydroxybutyl (meth)acrylate is particularly preferred.

The carboxyl group-containing monomer is a compound containing a carboxyl group and a polymerizable unsaturated double bond, such as a (meth)acryloyl group or a vinyl group, in the structure thereof. Specific examples of the carboxyl group-containing monomer include (meth)acrylic acid, carboxyethyl (meth) acrylate, carboxypentyl (meth)acrylate, itaconic acid, maleic acid, fumaric acid, and crotonic acid. Among these carboxyl group-containing monomers, acrylic acid is preferred from the viewpoints of copolymerizability, price, and pressure-sensitive adhesive properties.

When the pressure-sensitive adhesive composition contains a crosslinking agent, the hydroxyl group-containing monomer or the carboxyl group-containing monomer functions as a reaction point with the crosslinking agent. The hydroxyl group-containing monomer or the carboxyl group-containing monomer is highly reactive with an intermolecular crosslinking agent, and is therefore preferably used to improve the cohesiveness and heat resistance of a resulting pressure-sensitive adhesive layer.

The mass ratio of the hydroxyl group-containing monomer is preferably 3 mass % or less, more preferably 0.01 to 3 mass %, even more preferably 0.1 to 2 mass %, even more preferably 0.2 to 2 mass %. A mass ratio of 0.01 mass % or more of the hydroxyl group-containing monomer is preferred from the viewpoints of crosslinking of the pressure-sensitive adhesive layer, durability, and pressure-sensitive adhesive properties. On the other hand, a mass ratio of more than 3 mass % is not preferred from the viewpoint of durability.

The mass ratio of the carboxyl group-containing monomer is preferably 10 mass % or less, more preferably 0.01 to 8 mass %, even more preferably 0.05 to 6 mass %, even more preferably 0.1 to 5 mass %. A mass ratio of 0.01 mass % or more of the carboxyl group-containing monomer is preferred from the viewpoint of durability.

The amide group-containing monomer is a compound containing an amide group and a polymerizable unsaturated double bond, such as a (meth)acryloyl group or a vinyl group, in the structure thereof. Specific examples of the amide group-containing monomer include: acrylamide-based monomers such as (meth)acrylamide, N,N-dimethyl (meth)acrylamide, N,N-diethyl (meth)acrylamide, N-isopropylacrylamide, N-methyl (meth) acrylamide, N-butyl (meth)acrylamide, N-hexyl (meth)acrylamide, N-methylol (meth)acrylamide, N-methylol-N-propane (meth)acrylamide, aminomethyl (meth)acrylamide, aminoethyl (meth)acrylamide, mercaptomethyl (meth)acrylamide, and mercaptoethyl (meth)acrylamide; N-acryloyl heterocyclic monomers such as N-(meth)acryloyl morpholine, N-(meth)acryloyl piperidine, and N-(meth)acryloylpyrrolidine; and N-vinyl group-containing lactam-based monomers such as N-vinyl pyrrolidone and N-vinyl-s-caprolactam. The amide group-containing monomer is preferred from the viewpoints of preventing a surface resistance value from increasing with time (particularly in a humidified environment) and satisfying durability. Among these amide group-containing monomers, N-vinyl group-containing lactam-based monomers are particularly preferred.

An increase in the mass ratio of the amide group-containing monomer tends to reduce anchorability to the optical film, and therefore the mass ratio is preferably 10 mass % or less, particularly preferably 5 mass % or less. From the viewpoint of preventing a surface resistance value from increasing with time (particularly in a humidified environment), the mass ratio is preferably 0.1 mass % or more. The mass ratio is preferably 0.3 mass % or more, more preferably 0.5 mass % or more.

Specific examples of the copolymerizable monomer other than those mentioned above include: acid anhydride group-containing monomers such as maleic anhydride and itaconic anhydride; caprolactone adducts of acrylic acid; sulfonic acid group-containing monomers such as allyl sulfonic acid, 2-(meth)acrylamido-2-methyl propanesulfonic acid, (meth)acrylamide propanesulfonic acid, and sulfopropyl (meth)acrylate; and phosphoric acid group-containing monomers such as 2-hydroxyethyl acryloyl phosphate.

Examples of another monomer for modification include: alkyl aminoalkyl (meth)acrylates such as aminoethyl (meth)acrylate, N,N-dimethyl aminoethyl (meth)acrylate, and t-butyl aminoethyl (meth)acrylate; alkoxyalkyl (meth)acrylates such as methoxyethyl (meth)acrylate and ethoxyethyl (meth)acrylate; succinimide-based monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide-based monomers such as N-cyclohexylmaleimide, N-isopropylmaleimide, N-laurylmaleimide, and N-phenylmaleimide; and itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Further, it is possible to use, as a monomer for modification, a vinyl-based monomer such as vinyl acetate or vinyl propionate, an epoxy group-containing (meth)acrylate such as glycidyl (meth)acrylate, a glycol-based (meth)acrylate such as polyethyleneglycol (meth)acrylate or polypropyleneglycol (meth)acrylate, or a (meth)acrylate monomer such as tetrahyrofurfuryl (meth)acrylate or silicone (meth)acrylate. Further, isoprene, butadiene, isobutylene, vinyl ether, and the like can be mentioned as the modifying monomer.

Other examples of the copolymerizable monomer include a silane-based monomer containing a silicon atom. Examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, 10-acryloyloxydecyltriethoxysilane, and the like.

The mass ratio of the another copolymerizable monomer in the (meth)acrylic polymer (A) is preferably about 0 to 10 mass %, more preferably about 0 to 7 mass %, even more preferably about 0 to 5 mass % with respect to the total mass of all the monomers (monofunctional monomers 100 mass %) constituting the (meth)acrylic polymer (A).

As the copolymerizable monomer, it is also possible to use a polyfunctional monomer having two or more unsaturated double bonds of a (meth)acryloyl group, a vinyl group or the like, such as an esterified substance of (meth)acrylic acid and polyalcohol, wherein the esterified substance includes: tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and polyester(meth)acrylate, epoxy(meth)acrylate and urethane(meth)acrylate obtained by adding, as the same functional group as that in the monomer component, two or more unsaturated double bonds of a (meth)acryloyl group, a vinyl group or the like, respectively, to polyester, epoxy and urethane as a backbone.

When the polyfunctional monomer or the like is used as the copolymerizable monomer, the polyfunctional monomer functions as a crosslinking component. The amount of the polyfunctional monomer to be used depends on the molecular weight thereof, the number of functional groups, etc., but is preferably 1 part by mass or less, more preferably 0.5 parts by mass or less per 100 parts by mass of the total amount of the monofunctional monomers. The lower limit of the amount is not particularly limited, but is preferably 0 parts by mass or more, more preferably 0.01 parts by mass or more. When the amount of the polyfunctional monomer to be used is within the above range, it is possible to improve adhesive strength.

Usually, the (meth)acrylic polymer (A) used in the present invention preferably has a weight-average molecular weight of 1,000,000 to 2,500,000. When durability, especially heat resistance is taken into consideration, the weight-average molecular weight is preferably 1,200,000 to 2,000,000. From the viewpoint of heat resistance, the weight-average molecular weight is preferably 1,000,000 or more. If the weight-average molecular weight is more than 2,500,000, the pressure-sensitive adhesive tends to be hard so that peeling-off is likely to occur. The molecular weight distribution represented by weight-average molecular weight (Mw)/number-average molecular weight (Mn) is preferably 1.8 or more and 10 or less, more preferably 1.8 to 7, even more preferably 1.8 to 5. From the viewpoint of durability, it is not preferred that the molecular weight distribution (Mw/Mn) exceeds 10. It is to be noted that the weight-average molecular weight and the molecular weight distribution (Mw/Mn) are determined from polystyrene equivalent values measured by GPC (gel permeation chromatography).

As regards production of the (meth)acrylic polymer(A), it is possible to appropriately select one of conventional production methods such as solution polymerization, bulk polymerization, emulsion polymerization, radiation (UV) polymerization and various radical polymerizations. The resulting (meth)acrylic polymer may be any type of copolymers such as a random copolymer, a block copolymer, and a graft copolymer.

It is to be noted that in solution polymerization, for example, ethyl acetate or toluene is used as a polymerization solvent. Specifically, a reaction in solution polymerization is usually performed by, for example, adding a polymerization initiator in an inert gas stream such as nitrogen under reaction conditions of about 50 to 70° C. and about 5 to 30 hours.

A polymerization initiator, a chain transfer agent, an emulsifier, or the like used in the radical polymerization is not particularly limited and may appropriately be selected. It is to be noted that the weight-average molecular weight of the (meth)acrylic polymer (A) can be controlled by the amount of a polymerization initiator or a chain transfer agent to be used and reaction conditions, and the amount of a polymerization initiator or a chain transfer agent to be used is appropriately adjusted depending on the type thereof.

The pressure-sensitive adhesive composition forming the pressure-sensitive adhesive layer used in the present invention contains a silane coupling agent (B) as a dopant. When the silane coupling agent (B) is used in combination with the (meth)acrylic polymer (A) containing, as a monomer unit, 80 mass % or more of an alkyl (meth)acrylate (a) having an alkyl group of 1 to 4 carbon atoms, it is possible to prevent peeling-off of the pressure-sensitive adhesive layer because of fat and oil or cream components.

As the silane coupling agent (B), at least one selected from among an epoxy group-containing silane coupling agent (b1) and a mercapto group-containing silane coupling agent (b2) is preferably used.

Examples of the epoxy group-containing silane coupling agent (b1) include: low molecular-weight (non-oligomer) epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; and oligomer epoxy group-containing silane coupling agents such as X-41-1053, X-41-1056, X-41-1059A, X-24-9590, and KR-516 manufactured by Shin-Etsu Chemical Co., Ltd. The epoxy group-containing silane coupling agent (b1) is highly effective at preventing prevent peeling-off of the pressure-sensitive adhesive layer because of fat and oil or cream components, and is therefore preferably a low molecular-weight (non-oligomer) epoxy group-containing silane coupling agent.

Examples of the mercapto group-containing silane coupling agent (b2) include: low molecular-weight (non-oligomer) mercapto group-containing silane coupling agents such as 3-mercaptopropyltrimethoxysilane, 3-mercaptopropylmethyldimethoxysilane, 3-mercaptopropyltriethoxysilane, 3-mercaptopropylmethyldiethoxysilane, β-mercaptomethylphenylethyltrimethoxysilane, mercaptomethyltrimethoxysilane, 6-mercaptohexyltrimethoxysilane, and 10-mercaptodecyltrimethoxysilane; and X-41-1805, X-41-1810, and X-41-1818 manufactured by Shin-Etsu Chemical Co., Ltd. The mercapto group-containing silane coupling agent (b2) is highly effective at preventing peeling-off of the pressure-sensitive adhesive layer because of fat and oil or cream components, and is therefore preferably an oligomer mercapto group-containing silane coupling agent.

Examples of a low molecular-weight silane coupling agent (B) other than those mentioned above include: an acetoacetyl group-containing silane coupling agent such as A100 manufactured by Soken Chemical & Engineering Co., Ltd.; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acryl group-containing silane coupling agents such as 3-acryloxypropyltrimethoxysilane and 3-methacryloxypropyltriethoxysilane; and an isocyanate group-containing silane coupling agent such as 3-isocyanatopropyltriethoxysilane. An example of an oligomer silane coupling agent other than those mentioned above includes KR-213 manufactured by Shin-Etsu Chemical Co., Ltd.

These silane coupling agents having two or more alkoxysilyl groups in their molecules are preferred because they are less likely to vaporize and are effective at improving durability due to the presence of two or more alkoxysilyl groups. Particularly, even when an adherend to which the optical film with a pressure-sensitive adhesive is to be applied is a transparent conductive layer (e.g., ITO) that is less likely to react with alkoxysilyl groups than glass, appropriate durability is achieved. It is to be noted that “oligomer” refers to a polymer formed of 2 or more and about less than 100 monomer units, and the oligomer silane coupling agent preferably has a weight-average molecular weight of about 300 to 30000.

The silane coupling agents (B) may be used singly or in combination of two or more of them, but the total content thereof is preferably 0.01 to 5 parts by mass, more preferably 0.02 to 3 parts by mass, even more preferably 0.05 to 1 part by mass, even more preferably 0.1 to 0.8 parts by mass per 100 parts by mass of the (meth)acrylic polymer (A). It is to be noted that as described above, the silane coupling agent (B) to be used is preferably at least one selected from among the epoxy group-containing silane coupling agent (b1) and the mercapto group-containing silane coupling agent (b2), and when these silane coupling agents (b1) and (b2) and another silane coupling agent are used in combination, the another silane coupling agent can be used in an amount of 3 parts by mass or less per 100 parts by mass of the (meth)acrylic polymer (A) and equal to or less than the amount of the silane coupling agent (B).

The pressure-sensitive adhesive composition may contain a crosslinking agent (C). For example, an organic crosslinking agent or a polyfunctional metal chelate can be used as the crosslinking agent (C). Examples of the organic crosslinking agent include isocyanate-based crosslinking agent, peroxide-based crosslinking agent, epoxy-based crosslinking agent, imine-based crosslinking agent and the like. The polyfunctional metal chelate is one in which a polyvalent metal is covalently or coordinately bonded to an organic compound. As the polyvalent metal atom, there can be mentioned, for example, Al, Cr, Zr, Co, Cu, Fe, Ni, V, Zn, In, Ca, Mg, Mn, Y, Ce, Sr, Ba, Mo, La, Sn, Ti. The covalently or coordinately bonded atom in the organic compound may be an oxygen atom. Examples of the organic compound include alkyl esters, alcohol compounds, carboxylic acid compounds, ether compounds, ketone compounds, and the like.

As the crosslinking agent (C), an isocyanate-based crosslinking agent is preferred. As the isocyanate-based crosslinking agent, a compound having at least two isocyanate groups can be used. Examples of such an isocyanate-based crosslinking agent to be used include well-known aliphatic polyisocyanates, alicyclic polyisocyanates, and aromatic polyisocyanates generally used for urethanization reaction.

The amount of the crosslinking agent (C) to be used is preferably 3 parts by mass or less, more preferably 0.01 to 3 parts by mass, even more preferably 0.02 to 2 parts by mass, even more preferably 0.03 to 1 part by mass per 100 parts by mass of the (meth)acrylic polymer (A). It is to be noted that if the amount of the crosslinking agent (C) is less than 0.01 parts by mass, crosslinking deficiency occurs in the pressure-sensitive adhesive so that durability and pressure-sensitive adhesive properties may not be satisfied, and on the other hand, if the amount of the crosslinking agent (C) is more than 3 parts by mass, the pressure-sensitive adhesive becomes too hard so that durability tends to reduce.

The pressure-sensitive adhesive composition used in the present invention may further contain another well-known dopant. For example, an antistatic agent, a coloring agent, a powder such as a pigment, a dye, a surfactant, a plasticizer, a tackifier, a surface smoother, a leveling agent, a softener, an antioxidant, an anti-aging agent, a light stabilizer, a UV absorber, a polymerization inhibitor, an inorganic or organic filler, a metallic powder, a particulate material, or a foil-like material may appropriately be added depending on the intended use. A redox system may be employed by adding a reducing agent within a controllable range. Such a dopant is preferably used in an amount of 5 parts by mass or less, more preferably 3 parts by mass or less, even more preferably 1 part by mass or less per 100 parts by mass of the (meth)acrylic polymer (A).

On the other hand, the pressure-sensitive adhesive composition used in the present invention does not contain a polyether compound having a polyether skeleton and a reactive silyl group at its at least one end. An example of such a polyether compound having a reactive silyl group includes one disclosed in JP-A-2010-275522. The polyether compound having a reactive silyl group is preferred in that it can improve reworkability, but is not preferred from the viewpoint of preventing peeling-off of the pressure-sensitive adhesive layer because of fat and oil or cream components. When the polyether compound having a reactive silyl group is used, peeling-off of the pressure-sensitive adhesive layer cannot be prevented even by using the silane coupling agent (B).

The pressure-sensitive adhesive layer used in the present invention can be bonded to an optical film (including at least one polarizing film) so as to be used as a pressure-sensitive adhesive layer attached optical film. The pressure-sensitive adhesive layer attached optical film can be obtained by forming a pressure-sensitive adhesive layer using the pressure-sensitive adhesive composition on at least one surface of an optical film.

Examples of a method for forming the pressure-sensitive adhesive layer include a method in which the pressure-sensitive adhesive composition is applied onto a separator subjected to release treatment and dried to remove a polymerization solvent or the like to form a pressure-sensitive adhesive layer, and then the pressure-sensitive adhesive layer is transferred onto an optical film (polarizing film) and a method in which the pressure-sensitive adhesive composition is applied onto an optical film (polarizing film) and dried to remove a polymerization solvent or the like to form a pressure-sensitive adhesive layer on the optical film. It is to be noted that when the pressure-sensitive adhesive is applied, at least one appropriate solvent other than a polymerization solvent may newly be added.

The thickness of the pressure-sensitive adhesive layer is not particularly limited, but is, for example, preferably about 10 to 30 μm, more preferably 15 to 20 μm because if the pressure-sensitive adhesive layer is too thin, adhesiveness to the image display unit tends to reduce or peeling-off is likely to occur during shrinkage caused by heating, and on the other hand, if the pressure-sensitive adhesive layer is too thick, fat and oil or cream components are likely to be absorbed by the pressure-sensitive adhesive layer so that peeling-off is likely to occur.

The pressure-sensitive adhesive layer usually has a degree of swelling with oleic acid of 100 mass % or more. When the degree of swelling with oleic acid is lower, an influence exerted by oleic acid is smaller. In the pressure-sensitive adhesive layer attached optical film according to the present invention, the influence of fat and oil or cream components on the pressure-sensitive adhesive layer can be kept small even when the degree of swelling with oleic acid of the pressure-sensitive adhesive layer exceeds 130% or is further 140% or more or 150% or more. When the degree of swelling with oleic acid of the pressure-sensitive adhesive layer exceeds 130%, the pressure-sensitive adhesive layer absorbs fat and oil or cream components so that their influence on other optical members can be reduced. On the other hand, if the degree of swelling with oleic acid of the pressure-sensitive adhesive layer is too large, the influence of fat and oil or cream components on the pressure-sensitive adhesive layer also becomes large, and therefore the degree of swelling with oleic acid is preferably 190% or less, preferably 180% or less.

### <Image Display Unit>

The image display unit forms part of an image display device together with the above-described optical film (including at least one polarizing film), and examples of the image display device include a liquid crystal display, an organic EL (electro-luminescent) display, and PDP (plasma display panel), and electronic paper.

Examples of the image display unit include liquid crystal cells for use in liquid crystal displays. The liquid crystal cell to be used may be of any type such as TN type, STN type, n type, VA type, or IPS type.

### <Image Display Panel>

The image display panel may be formed using, in addition to the above-described optical film, other optical films laminated depending on suitability for their respective arrangement positions. For example, in a liquid crystal display panel, at least a polarizing film is provided on the opposite side from the viewing side of a liquid crystal cell, but the polarizing film is not particularly limited. Examples of the other optical films include optical layers that may be used for forming liquid crystal displays and the like, such as reflectors, semi-transmissive plates, retardation films (including half-wavelength plates and quarter-wavelength plates), viewing angle compensating films, and brightness enhancement films. One or two or more of these layers may be used.

### <Image Display Device>

Various image display devices, such as liquid crystal displays, according to the present invention may be formed in a conventional manner. A liquid crystal display is formed by, for example, appropriately assembling constituent parts such as an optional lighting system and incorporating a driving circuit. A liquid crystal display is generally formed by, for example, appropriately assembling constituent parts such as a liquid crystal cell (having a structure of glass substrate/liquid crystal layer/glass substrate), polarizing films provided on both sides thereof, and an optional lighting system and incorporating a driving circuit. The above-described optical film is provided on the viewing side, and another polarizing film is provided on the other side. Further, the liquid crystal display may use a backlight or reflector in its lighting system, if necessary. Further, the liquid crystal display may be formed by providing, as one or two or more layers, an appropriate part(s) such as a diffusing plate, an anti-glare layer, an anti-reflection film, a protective film, a prism array, a lens array sheet, a light diffusing plate, or a backlight in an appropriate position(s).

### EXAMPLES

Although the present invention will be described in detail below based on Production Examples and Examples, it should be understood that the present invention is not limited to such Examples. The parts and percentages in each Example are on a weight basis. Room temperature standing conditions not specified below are all 23° C. and 65% RH.

<Measurement of Weight Average Molecular Weight of (Meth)acrylic Polymer (A)>

The weight average molecular weight (Mw) of the (meth)acrylic polymer was measured by GPC (gel permeation chromatography). The ratio Mw/Mn was also measured in the same manner.
Analyzer: HLC-8120 GPC, manufactured by Tosoh Corporation
Column: G7000H_{XL}+GMH_{XL}+GMH_{XL}, manufactured by Tosoh Corporation
Column size: 7.8 mm φ×30 cm each in total 90 cm
Column temperature: 40° C.
Flow rate: 0.8 mL/min
Injection volume: 100 μL
Eluent: Tetrahydrofuran
Detector: Differential refractometer (RI)
Standard sample: Polystyrene

### <Preparation of Optical Film>

Optical films A to D used in Examples, Comparative Examples, and Reference Examples were prepared in the following manner.

### (Preparation of Thin Polarizer)

Corona treatment was performed on one surface of an amorphous isophthalic acid-copolymerized polyethylene terephthalate (IPA-copolymerized PET) film (thickness: 100 μm) substrate having a water absorption ratio of 0.75% and a Tg of 75° C. Then, an aqueous solution containing polyvinyl alcohol (polymerization degree: 4200, saponification degree: 99.2 mol %) and acetoacetyl-modified PVA (polymerization degree: 1200, acetoacetyl modification degree: 4.6%, saponification degree: 99.0 mol % or more, manufactured by The Nippon Synthetic Chemical Industry Co., Ltd. under the product name of “Gohsefimer Z200”) in a ratio of 9:1 was applied onto the corona-treated surface at 25° C. and dried to form a PVA-based resin layer having a thickness of 11 μm. In this way, a laminate was formed.

The obtained laminate was subjected to free-end uniaxial stretching to 2.0 times in the lengthwise direction (longitudinal direction) between rolls different in peripheral speed in an oven at 120° C. (auxiliary in-air stretching).

Then, the laminate was immersed in an insolubilization bath (an aqueous boric acid solution obtained by adding 4 parts of boric acid to 100 parts of water) at a liquid temperature of 30° C. for 30 seconds (insolubilization).

Then, the laminate was immersed in a dye bath at a liquid temperature of 30° C. while the iodine concentration and the immersion time were adjusted to allow a resulting polarizing plate to have a predetermined transmittance. In this example, the laminate was immersed for 60 seconds in an aqueous iodine solution obtained by adding 0.2 parts of iodine and 1.0 part of potassium iodide to 100 parts of water (dyeing).

Then, the laminate was immersed for 30 seconds in a crosslinking bath (an aqueous boric acid solution obtained by adding 3 parts of potassium iodide and 3 parts of boric acid to 100 parts of water) at a liquid temperature of 30° C. (crosslinking).

Then, the laminate was subjected to uniaxial stretching in the lengthwise direction (longitudinal direction) between rolls different in peripheral speed to a total stretch ratio of 5.5 times while immersed in an aqueous boric acid solution (an aqueous solution obtained by adding 4 parts of boric acid and 5 parts of potassium iodide to 100 parts of water) at a liquid temperature of 70° C. (in-water stretching).

Then, the laminate was immersed in a washing bath (an aqueous solution obtained by adding 4 parts of potassium iodide to 100 parts of water) at a liquid temperature of 30° C. (washing).

In this way, an optical film laminate having a 5 μm-thick polarizer was obtained.

### (Transparent Protective Film)

Acrylic film 1: A 40 μm-thick (meth)acrylic resin film having a lactone ring structure whose easy-adhesion-treated surface had been subjected to corona treatment was used.

TAC film: A 40 μm-thick triacetyl cellulose film subjected to saponification was used.

COP film 1: A cycloolefin-based resin film having a thickness of 13 μm (manufactured by Zeon Corporation under the product name of ZF14-013) was used.

COP film 2: A cycloolefin-based resin film having a thickness of 25 μm (manufactured by Zeon Corporation under the product name of ZF14-013) was used.

All the transparent protective films were “optically isotropic”, and had an in-plane retardation Re(550) of 0 nm to 10 nm and a thickness direction retardation Rth(550) of −10 nm to +10 nm.

### (Preparation of Adhesive Used for Transparent Protective Film)

A UV curable adhesive was prepared by mixing 10 parts of N-hydroxyethyl acrylamide, 30 parts of acryloyl morpholine, 45 parts of 1,9-nonanediol diacrylate, 10 parts of an acrylic oligomer obtained by polymerizing a (meth)acrylic monomer (ARUFONUP1190 manufactured by Toagosei Co., Ltd.), 3 parts of a photopolymerization initiator (IRGACURE 907 manufactured by BASF), and 2 parts of a polymerization initiator (KAYACURE DETX-S manufactured by Nippon Kayaku Co., Ltd.).

### (Retardation Film)

First retardation film: A 18 μm-thick cyclic olefin-based film (refractive index characteristics: nx>ny>nz, in-plane retardation: 116 nm) was used.

Second retardation film: A 6 μm-thick modified polyethylene film (refractive index characteristics: nz>nx>ny, in-plane retardation: 35 nm) was used.

### <One-Side-Protected Polarizing Film>

The above-described transparent protective film (thickness 40 μm: acrylic film 1 or TAC film) was bonded to the surface of the polarizer of the above-descried optical film laminate while the above-described UV curable adhesive a was applied so that an adhesive layer after curing had a thickness of 1 μm, and then the adhesive was cured by irradiation with UV light as an active energy ray. The irradiation with UV light was performed using a gallium-doped metal halide lamp (irradiation device: Light HAMMER10 manufactured by Fusion UV Systems, Inc., bulb: V bulb, peak illuminance: 1600 mW/cm², integrated irradiation dose: 1000/mJ/cm² (wavelength: 380 to 440 nm), and the illuminance of the UV light was measured using Sola-Check system manufactured by Solatell Ltd. Then, the amorphous PET substrate was peeled off to prepare a 46 μm-thick one-side-protected polarizing film using a thin polarizer.

A one-side-protected polarizing film 1 using the acrylic film 1 was used to prepare a one-side-protected polarizing film with a retardation film that will be described below.

When the TAC film was used, the one-side-protected polarizing film was directly used as a one-side-protected polarizing film 2.

<One-Side-Protected Polarizing Film with Retardation Film>

The first retardation film and the second retardation film were bonded in order to the thin polarizer side of the one-side-protected polarizing film 1 to obtain a 72 μm-thick one-side-protected polarizing film with a retardation film. The bonding was performed using the same UV curable adhesive a as described above so that a 1 μm-thick adhesive layer was formed. It is to be noted that the first retardation film was bonded so that its slow axis formed an angle of 0° with the absorption axis of the polarizer, and the second retardation film was bonded so that its slow axis formed an angle of 90° with the absorption axis of the polarizer.

### <Preparation of Double-Side-Protected Polarizing Film>

The above-described COP film 1 (thickness: 25 μm) was bonded to the surface of the polarizer of the optical film laminate while the above-described UV curable adhesive a was applied so that an adhesive layer after curing had a thickness of 1 μm, and then the adhesive was cured by irradiation with UV light as an active energy ray. The irradiation with UV light was performed using a gallium-doped metal halide lamp (irradiation device: Light HAMMER10 manufactured by Fusion UV Systems, Inc., bulb: V bulb, peak illuminance: 1600 mW/cm², integrated irradiation dose: 1000/mJ/cm² (wavelength: 380 to 440 nm), and the illuminance of the UV light was measured using Sola-Check system manufactured by Solatell Ltd. Then, the amorphous PET substrate was removed, and the above-described COP film 2 (thickness: 13 μm) was bonded to a surface, from which the amorphous PET substrate had been removed, with the above-described adhesive, and then the adhesive was cured in the same manner to produce a 45 μm-thick double-side-protected polarizing film using a thin polarizer.

<Preparation of Film with Surface-Treated Layer: ARTAC: Thickness 44 μm)>

A 4 μm-thick antireflective layer was formed by sputtering on a 40 μm-thick triacetyl cellulose film.

<Preparation of Film with Surface-Treated Layer: ARTAC: Thickness 84 μm>

A 4 μm-thick antireflective layer was formed by sputtering on an 80 μm-thick triacetyl cellulose film.

<Preparation of Film with Surface-Treated Layer: LCTAC: Thickness 42 μm)>

A 2 μm-thick liquid crystal retardation layer was formed by coating on a 40 μm-thick triacetyl cellulose film.

### <Preparation of Pressure-Sensitive Adhesive Layer A>

### (Preparation of Acrylic Polymer)

A monomer mixture containing 100 parts of n-butyl acrylate and 5 parts of acrylic acid was placed in a four-necked flask equipped with a stirring blade, a thermometer, a nitrogen gas introduction tube, and a cooler. Further, 0.1 parts of 2,2′-azobis(isobutyronitrile) was added as a polymerization initiator per 100 parts of the monomer mixture (solid content) together with 100 parts of ethyl acetate, and nitrogen gas was introduced while the mixture was gently stirred to perform nitrogen purge. Then, a polymerization reaction was performed for 8 hours while the temperature of the liquid in the flask was kept at about 55° C. to prepare a solution of an acrylic polymer having a weight-average molecular weight (Mw) of 1,600,000.

### (Preparation of Pressure-Sensitive Adhesive Composition)

A solution of an acrylic pressure-sensitive adhesive composition was prepared by adding 0.45 parts of an isocyanate-based crosslinking agent (Coronate L manufactured by Tosoh Corporation, trimethylolpropane tolylenediisocyanate) per 100 parts of solid content of the acrylic polymer solution obtained above.

### (Formation of Pressure-Sensitive Adhesive Layer)

Then, the solution of the acrylic pressure-sensitive adhesive composition was applied onto one surface of a polyethylene terephthalate film treated with a silicone-based release agent (separator film: MRF38 manufactured by Mitsubishi Polyester Film GmbH) so that a pressure-sensitive adhesive layer after drying had a thickness of 23 μm or 12 μm, and was dried at 155° C. for 1 minute to form a pressure-sensitive adhesive layer A on the surface of the separator film.

Optical films A to F were prepared by laminating the polarizing film and the film with a surface-treated layer so as to have the following structure. The laminating was performed by bonding the polarizing film to the triacetyl cellulose film side of the film with a surface-treated layer with the pressure-sensitive adhesive layer A being interposed between them. In the case of the one-side-protected polarizing film with a retardation film, the laminating was performed by bonding the pressure-sensitive adhesive layer A to the acrylic film 1 side of the polarizing film. In the case of the one-side-protected polarizing film 2, the laminating was performed by bonding the pressure-sensitive adhesive layer A to the TAC film side of the polarizing film. In the case of the double-side-protected polarizing film, the laminating was performed by bonding the pressure-sensitive adhesive layer A to the COP film 2 side of the polarizing film.

Optical film A (total thickness: 128 μm): ARTAC (thickness: 44 μm)/pressure-sensitive adhesive layer A (thickness: 12 μm)/one-side-protected polarizing film with retardation film (thickness: 72 μm)

Optical film B (total thickness: 179 μm): ARTAC (thickness: 84 μm)/pressure-sensitive adhesive layer A (thickness: 23 μm)/one-side-protected polarizing film with retardation film (thickness: 72 μm)

Optical film C (total thickness: 244 μm): ARTAC (thickness: 84 μm)/pressure-sensitive adhesive layer A (thickness 23 μm)/LCTAC (thickness: 42 μm)/pressure-sensitive adhesive layer A (thickness 23 μm)/one-side-protected polarizing film with retardation film (thickness: 72 μm)

Optical film D (total thickness 72 μm): one-side-protected polarizing film with retardation film (thickness: 72 μm)

Optical film E (total thickness: 217 μm): ARTAC (thickness: 84 μm)/pressure-sensitive adhesive layer A (thickness 23 μm)/LCTAC (thickness: 42 μm)/pressure-sensitive adhesive layer A (thickness 23 μm)/double-side-protected polarizing film (thickness: 45 μm)

Optical film F (total thickness: 244 μm): ARTAC (thickness: 84 μm)/pressure-sensitive adhesive layer A (thickness: 23 μm)/LCTAC (thickness: 42 μm)/pressure-sensitive adhesive layer A (thickness: 23 μm)/one-side-protected polarizing film 2 (thickness: 72 μm)

### Example 1

### (Preparation of Acrylic Polymer)

A monomer mixture containing 81.9 parts of n-butyl acrylate, 13.2 parts of benzyl acrylate, 0.1 parts of 4-hydroxybutyl acrylate, and 4.8 parts of acrylic acid was placed in a four-necked flask equipped with a stirring blade, a thermometer, a nitrogen gas introduction tube, and a cooler. Further, 0.1 parts of 2,2′-azobis(isobutyronitrile) as a polymerization initiator was added per 100 parts of the monomer mixture (solid content) together with 100 parts of ethyl acetate, and nitrogen gas was introduced while the mixture was gently stirred to perform nitrogen purge. Then, a polymerization reaction was performed for 8 hours while the temperature of the liquid in the flask was kept at about 55° C. to prepare a solution of an acrylic polymer having a weight-average molecular weight (Mw) of 1,600,000.

### (Preparation of Pressure-Sensitive Adhesive Composition)

A solution of an acrylic pressure-sensitive adhesive composition was prepared by adding 0.2 parts of an oligomer mercapto group-containing silane coupling agent (X-41-1810 manufactured by Shin-Etsu Chemical Co., Ltd.) and 0.45 parts of an isocyanate-based crosslinking agent (Coronate L manufactured by Tosoh Corporation, trimethylolpropane tolylenediisocyanate) were added per 100 parts of solid content of the acrylic polymer solution obtained above.

### (Formation of Pressure-Sensitive Adhesive Layer)

Then, the solution of the acrylic pressure-sensitive adhesive composition was applied onto one surface of a polyethylene terephthalate film treated with a silicone-based release agent (separator film: MRF38 manufactured by Mitsubishi Polyester Film GmbH) so that a pressure-sensitive adhesive layer after drying had a thickness of 20 μm, and was dried at 155° C. for 1 minute to form a pressure-sensitive adhesive layer B on the surface of the separator film.

(Preparation of Optical Film with Pressure-Sensitive Adhesive Layer and Production of Image Display Panel)

An image display unit (including a 15-inch (diagonal) liquid crystal cell, thickness: 300 μm) was prepared.

The pressure-sensitive adhesive layer B prepared above was bonded to the one-side-protected polarizing film with a retardation film side of the optical film A prepared above to prepare a pressure-sensitive adhesive layer attached optical film (a polarizing film whose short edge and long edge were both shorter by 4 mm than those of the liquid crystal cell). The separator film was peeled off from the pressure-sensitive adhesive layer attached optical film, and then the optical film A (the second retardation film side thereof) was bonded using a laminator to the viewing side of the image display unit with the pressure-sensitive adhesive layer B being interposed between them to produce an image display panel (a liquid crystal display panel). Then, the image display panel was subjected to autoclave treatment at 50° C. and 0.5 MPa for 15 minutes to allow the optical film A to completely come into close contact with the image display unit. Then, the obtained image display panel was laser cut to have a 15-inch size.

(Production of Image Display Panel with Bezel)

As an elastic intermediate layer, a rubber molded product having a width of 1 mm and a height of 5 mm (total width of holding part: 1.5 mm, 6 convex parts (such portions as shown in FIG. 4), the length of one of the edges of the elastic intermediate layer was 5 cm from each corner) was prepared which was processed to fit the periphery of the image display panel (15-inch size).

Further, as an external bezel, a resin plate (frame) having a width of 1 mm and a height of 3 mm and subjected to sputtering to have a metal-like surface was prepared (which was integrally formed with a housing frame having a recess into which the panel could be inserted). The resin plate was formed to fit the image display panel (15-inch size).

The elastic intermediate layer was attached to the housing integrally formed with the external bezel, and then the image display panel was incorporated into the housing (with a space of 1 mm or less) to produce an image display panel with a bezel having a structure shown in FIG. 2 (FIG. 2A, FIG. 2B), in which the elastic intermediate layer and the external bezel were provided in order on the outside of the entire edge face of the image display device. In the obtained image display panel with a bezel, the elastic intermediate layer was provided so as to project from the viewing-side outermost surface of the image display panel (optical film A) by 1 mm. The elastic intermediate layer was in contact with the edge face of the image display panel. The external bezel was fixed to the elastic intermediate layer with an adhesive.

### Examples 2 to 32 and Comparative Examples 1 to 8

A pressure-sensitive adhesive layer B was formed in the same manner as in Example 1 except that the composition or component ratio of the monomer mixture used for preparation of the acrylic polymer, the type or amount of the silane coupling agent used for preparation of the pressure-sensitive adhesive composition, the type or content of the crosslinking agent used for preparation of the pressure-sensitive adhesive composition, or the thickness of the pressure-sensitive adhesive layer formed were changed as shown in Table 1. Further, pressure sensitive adhesive layer attached optical films were prepared in the same manner as in Example 1 using the pressure-sensitive adhesive layer B obtained above and the optical films A to F shown in Table 1, and then image display panels were produced. Further, image display panels with a bezel were produced in the same manner as in Example 1.

It is to be noted that when the optical film E was used, the pressure-sensitive adhesive layer B was bonded to the double-side-protected polarizing film side of the optical film E to prepare a pressure-sensitive adhesive layer attached optical film, and when the optical film F was used, the pressure-sensitive adhesive layer B was bonded to the one-side-protected polarizing film 2 side of the optical film F to prepare a pressure-sensitive adhesive layer attached optical film.

In Example 30, an image display panel with a bezel having a structure shown in FIG. 3 (FIG. 3A, FIG. 3B) was produced. This image display panel with a bezel was assembled using, as an internal bezel, a resin plate (frame) having a width of 20 mm and a height of 2 mm and subjected to sputtering to have a metal-like surface. The resin plate was formed so as to fit the image display panel (15-inch size). An elastic intermediate layer was provided so that a space of 15 mm was made between the elastic intermediate layer and the edge face of the image display panel. An external bezel used and the elastic intermediate layer used each had a size such that the above-described space could be made. The external bezel was fixed to the elastic intermediate layer with an adhesive. The internal bezel was fixed to the end of the outermost surface of the image display panel and the elastic intermediate layer with an adhesive.

It is to be noted that the pressure-sensitive adhesive composition used for forming the pressure-sensitive adhesive layer of Comparative Example 3 was prepared in the following manner.

0.050 parts of 1-hydroxycyclohexylphenyl ketone (manufactured by BASF under the product name of IRGACURE 184) and 0.050 parts of 2,2-dimethoxy-1,2-diphenylethan-1-one (manufactured by BASF under the product name of IRGACURE 651) as photopolymerization initiators were added to a monomer mixture containing 67 parts of 2-ethylhexyl acrylate (2EHA), 15 parts of 2-hydroxyethyl acrylate (HEA), and 18 parts of N-vinyl-2-pyrrolidone (NVP), and then the mixture was irradiated with UV light until its viscosity became about 20 Pass (measurement conditions: BH viscometer No. 5 rotor, 10 rpm, measurement temperature 30° C.) to obtain a prepolymer composition in which the monomer components were partially polymerized (polymerization ratio: 9%). Then, 0.09 parts of hexanediol diacrylate (HDDA) was added to and mixed with the prepolymer composition to obtain a pressure-sensitive adhesive composition. The pressure-sensitive adhesive composition was applied onto the release-treated surface of a release film (manufactured by Mitsubishi Plastics Inc. under the product name of “MRF #38”) so as to have a thickness of 20 μm. In this way, a pressure-sensitive adhesive composition layer was formed. Then, the other surface of the pressure-sensitive adhesive composition layer was bonded to the release-treated surface of a release film (manufactured by Mitsubishi Plastics Inc. under the product name of “MRN #38”), and the pressure-sensitive adhesive composition layer was photo-cured by irradiation with UV light under conditions of an illuminance of 4 mW/cm² and a light quantity of 1200 mJ/cm² to form a pressure-sensitive adhesive layer. In this way, a pressure-sensitive adhesive sheet was prepared.

### Reference Example 1 (Production of Image Display Panel with Cover Glass-Bezel)

An image display panel with a bezel having a structure shown in FIG. 5 was produced using the same image display panel as produced in Example 1.

As an external bezel, the same one as used in Example 1 was prepared.

As a cover glass, a tempered glass plate having a thickness of 1500 μm was prepared which was formed so as to fit the image display panel (15-inch size).

The image display panel was assembled by attaching the external bezel to the outside of the entire edge face of the image display panel. The external bezel was fixed to the image display panel with an adhesive. The cover glass was bonded with a pressure-sensitive adhesive layer (LUCIACS CS9864 manufactured by Nitto Denko Corporation).

The image display panels with a bezel and the pressure-sensitive adhesive layer attached optical films obtained above in Examples, Comparative Examples, and Reference Example were evaluated in the following manner. Evaluation results are shown in Table 1.

### <Test Using Chemicals in Humidified Environment>

10 mL of each of the following chemicals was dropped to the (entire) inside of the elastic intermediate layer of the obtained image display panel with a bezel (in the case of Reference Example, to the inside of the external bezel) using a 2-mL syringe.

Oleic acid: oleic acid manufactured by Wako Pure Chemical Industries, Ltd. (Extra Pure, content: 65%)

Vaseline moisture cream: UJ body milk COAB manufactured by Unilever (moisture content: 63%, glycerin content: 26%)

Sunscreen cream: EDGEWELL PERSONAL CARE, Banana Boat Sunscreen Lotion SPF 30

After the chemical was dropped, the image display panel with a bezel was stored for 72 hours under conditions of 65° C. and 90% RH, and was then allowed to stand at ordinary temperature (23° C.). Then, the pressure-sensitive adhesive layer attached optical film was taken out from the image display panel with a bezel, and the appearance thereof was visually observed to evaluate the peeling-off of the pressure-sensitive adhesive layer B according to the following criteria.

### (Evaluation Criteria)

⊚: No peeling-off was observed.

◯: No peeling-off was observed, but the edge was swelled by glue swelling.

Δ: Slight peeling-off of 0.5 mm or less was observed.

NG: Peeling-off was observed (the amount of peeling-off (mm) is also shown in Table 1).

<Measurement of Degree of Swelling with Oleic Acid>

The pressure-sensitive adhesive layer B formed on the surface of the separator film used in each example was cut to have a size of 20 mm×40 mm to prepare a sample, and the mass (W1) of the sample was measured. Then, the sample was immersed in oleic acid for 24 hours under conditions of 60° C. and a humidity of 90% and was then taken out from oleic acid. The surface of the sample was washed with ethanol and then dried at 110° C. for 3 hours. After the drying, the mass (W3) of the sample was measured to calculate the ratio of swelling with oleic acid of the acrylic pressure-sensitive adhesive using the following formula (2). The mass (W2) of the separator film of the sample was separately measured.

Swelling ratio (%)={(W3−W2)/(W1−W2)}×100

### <Resistance to Cracking>

Similarly to the above-described <Test using chemicals in humidified environment>, 10 mL of oleic acid was dropped to the (entire) inside of the elastic intermediate layer of the image display panel with a bezel (in the case of Reference Example, to the inside of the external bezel) using a 2-mL syringe. After the chemical was dropped, the image display panel with a bezel was stored for 72 hours under conditions of 65° C. and 90% RH, and was then allowed to stand at ordinary temperature (23° C.).

Then, the pressure-sensitive adhesive layer attached optical film was taken out of the image display panel with a bezel and placed so that its pressure-sensitive adhesive layer side was down to visually observe the transparent protective film of the polarizing film from above with a microscope (10×) to determine whether or not cracking had occurred (i.e., to determine whether or not the transparent protective film looked white due to cracking).

It is to be noted that in Comparative Example 8 (an example using the double-side-protected polarizing film), the side face of the pressure-sensitive adhesive layer attached optical film taken out of the image display panel with a bezel was visually observed. When cracking was observed in either of the transparent protective films provided on both surfaces of the polarizer when the pressure-sensitive adhesive layer attached optical film was viewed from its side face, cracking was deemed to have occurred.

TABLE 1

| | | Image Display Panel with Bezel | | | | | | | | | | | | | | | | | | |
|---|---|---|---|---|---|---|---|---|---|---|---|---|---|---|---|---|---|---|---|---|
| | | | | | Pressure-Sensitive Adhesive Layer | | | | | | | | | | | | | | | |
| | | | | | | (Meth)Acrylic Polymer (A): (Parts) | | | | | | | | | | | | | | |
| | | | Optical Film | | | | | | | | | | | Alkyl | Aromatic | | | | | |
| | | | | Thick- | | | | | | | | | | (Meth) | Ring- | | Hydroxyl | | Amide | Corboxyl |
| | | | | ness | | | | | | | | | | Acrylate | Containing | | Group- | | Group- | Group- |
| | | | | Dis- | Thick- | Monomer (a) Including BA | | | | | | | | Other | (Meth) | | Containing | | Containing | Containing |
| | | Struc- | Com- | tance | ness | | | t- | n- | | Biscoat | Acrylo- | | Than (a) | Acrylate | | Monomer | | Monomer | Monomer |
| | | ture | ponent | T(μm) | (μm) | MA | EA | BA | BA | MMA | 3F | nitrile | MEA | 2EHA | BzA | PEA | 4HBA | HEA | NVP | AA |
| Examples | 1 | FIG. 2 | Optical | 128 | 20 | | | | 81.9 | | | | | | 13.2 | | 0.1 | | | 4.8 |
| | | | Film A | | | | | | | | | | | | | | | | | |
| | 2 | | Optical | 179 | 20 | | | | 81.9 | | | | | | 13.2 | | 0.1 | | | 4.8 |
| | 3 | | Film B | | 15 | | | | 81.9 | | | | | | 13.2 | | 0.1 | | | 4.8 |
| | 4 | | | | 10 | | | | 81.9 | | | | | | 13.2 | | 0.1 | | | 4.8 |
| | 5 | | | | 20 | | | | 81.9 | | | | | | 13.2 | | 0.1 | | | 4.8 |
| | 6 | | | | 20 | | | | 81.9 | | | | | | 13.2 | | 0.1 | | | 4.8 |
| | 7 | | | | 20 | 40 | | | 41.9 | | | | | | 13.2 | | 0.1 | | | 4.8 |
| | 8 | | | | 20 | | 20 | | 61.9 | | | | | | 13.2 | | 0.1 | | | 4.8 |
| | 9 | | | | 20 | | 40 | | 41.9 | | | | | | 13.2 | | 0.1 | | | 4.8 |
| | 10 | | | | 20 | | 50 | | 31.9 | | | | | | 13.2 | | 0.1 | | | 4.8 |
| | 11 | | | | 20 | | 20 | | 61.9 | | | | | | 13.2 | | 0.1 | | | 4.8 |
| | 12 | | | | 20 | | | 30 | 51.9 | | | | | | 13.2 | | 0.1 | | | 4.8 |
| | 13 | | | | 20 | | | | 95.1 | | | | | | | | | 0.1 | | 4.8 |
| | 14 | | | | 20 | | | | 89.82 | 8 | | | | | | | 0.48 | | 1.5 | 0.2 |
| | 15 | | | | 20 | | | | 99 | | | | | | | | 1 | | | |
| | 16 | | | | 20 | | | | 51.9 | | 30 | | | | 13.2 | | 0.1 | | | 4.8 |
| | 17 | | | | 20 | | 33.5 | | 33.5 | | 30 | | | | | | | | | 3 |
| | 18 | | | | 20 | | 10 | | 39 | | 50 | | | | | | 1 | | | |
| | 19 | | | | 20 | | | | 82 | | | 15 | | | | | | | | 3 |
| | 20 | | | | 20 | | | | 70 | | | 27 | | | | | | | | 3 |
| | 21 | | | | 20 | | | | 20 | | | | 80 | | | | | | | |
| | 22 | | | | 20 | | | | 0 | | | | 100 | | | | | | | |
| | 23 | | | | 20 | | | | 81.9 | | | | | | 13.2 | | 0.1 | | | 0.48 |
| | 24 | | | | 20 | | | | 81.9 | | | | | | 13.2 | | 0.1 | | | 0.48 |
| | 25 | | | | 20 | | | | | | | | | 89.98 | | | 10 | | | 0.02 |
| | 26 | | | | 20 | | | | 80.3 | | | | | | 0.2 | 16 | 0.5 | | 3 | |
| | 27 | | | | 20 | | | | 81.9 | | | | | | 13.2 | | 0.1 | | | 4.8 |
| | 28 | | | | 20 | | | | 81.9 | | | | | | 13.2 | | 0.1 | | | 4.8 |
| | 29 | | Optical | 244 | 20 | | | | 81.9 | | | | | | 13.2 | | 0.1 | | | 4.8 |
| | | | Film C | | | | | | | | | | | | | | | | | |
| | 30 | FIG. 3 | Optical | 128 | 20 | | | | 81.9 | | | | | | 13.2 | | 0.1 | | | 4.8 |
| | | | Film A | | | | | | | | | | | | | | | | | |
| | 31 | FIG. 2 | Optical | 244 | 15 | | | | 81.9 | | | | | | 13.2 | | 0.1 | | | 4.8 |
| | 32 | | Film F | 244 | 10 | | | | 81.9 | | | | | | 13.2 | | 0.1 | | | 4.8 |
| Com- | 1 | FIG. 2 | Optical | 128 | 20 | | | | 81.9 | | | | | | 13.2 | | 0.1 | | | 4.8 |
| parative | | | Film A | | | | | | | | | | | | | | | | | |
| Examples | 2 | | Optical | 179 | 20 | | | | 81.9 | | | | | | 13.2 | | 0.1 | | | 4.8 |
| | | | Film B | | | | | | | | | | | | | | | | | |
| | 3 | | | | | | | | | | | | | 67 | | | | 18 | 15 | |
| | 4 | | | | 20 | | | | 71.9 | | | | | | 13.2 | | 0.1 | | 10 | 4.8 |
| | 5 | | Optical | 244 | 20 | | | | 81.9 | | | | | | 13.2 | | 0.1 | | | 4.8 |
| | | | Film C | | | | | | | | | | | | | | | | | |
| | 6 | | Optical | 72 | 20 | | | | 81.9 | | | | | | 13.2 | | 0.1 | | | 4.8 |
| | | | Film D | | | | | | | | | | | | | | | | | |
| | 7 | | | | 20 | | | | 81.9 | | | | | | 13.2 | | 0.1 | | | 4.8 |
| | 8 | | Optical | 217 | 20 | | | | 81.9 | | | | | | 13.2 | | 0.1 | | | 4.8 |
| | | | Film E | | | | | | | | | | | | | | | | | |
| Reference | 1 | FIG. 5 | Optical | 128 | 20 | | | | 81.9 | | | | | | 13.2 | | 0.1 | | | 4.8 |
| Example | | | Film A | | | | | | | | | | | | | | | | | |

| | | Image Display Panel with Bezel | | | | | | | | | | | | | | | |
|---|---|---|---|---|---|---|---|---|---|---|---|---|---|---|---|---|---|
| | | Pressure-Sensitive Adhesive Layer | | | | | | | | | | | Evaluation | | | | |
| | | Rework- | | | | | | | | | | | | | | Degree | Resistance |
| | | ability | | | | | | | | | | | Test Using Chemicals in | | | of | to cracking |
| | | En- | Silane Coupling Agent (B): (Parts) | | | | | | | | | | Humidified Environment | | | Swelling | (cracking occurring |
| | | chancer: | Low Molecular | | | Oligomer Type | | Crosslinking Agent (C): (Parts) | | | | | | Vaseline | Sun- | with | in transparent |
| | | (Parts) | weight | | | X41- | X41- | C/ | Tetrad- | | | | Oleic | Moisture | screen | Oleic | protective film |
| | | SAT10 | KBM403 | KBM573 | A100 | 1810 | 1056 | HX | C | C/L | D160N | HDDA | Acid | Cream | Cream | Acid | of polarizing film) |
| Examples | 1 | | | | | 0.2 | | | | 0.45 | | | ◯ | ◯ | ◯ | 171 | No crack |
| | 2 | | | | | 0.2 | | | | 0.45 | | | ◯ | ◯ | ◯ | 171 | No crack |
| | 3 | | | | | 0.2 | | | | 0.45 | | | ⊙ | ⊙ | ⊙ | 149 | No crack |
| | 4 | | | | | 0.2 | | | | 0.45 | | | ⊙ | ⊙ | ⊙ | 131 | No crack |
| | 5 | | | | | 0.1 | | | | 0.45 | | | ◯ | ◯ | ◯ | 149 | No crack |
| | 6 | | 0.2 | | | | | | | 0.45 | | | ⊙ | ◯ | ◯ | 172 | No crack |
| | 7 | | | | | 0.2 | | | | 0.45 | | | ⊙ | ⊙ | ⊙ | 122 | No crack |
| | 8 | | | | | 0.2 | | | | 0.45 | | | ⊙ | ⊙ | ⊙ | 120 | No crack |
| | 9 | | | | | 0.2 | | | | 0.45 | | | ⊙ | ⊙ | ⊙ | 109 | No crack |
| | 10 | | | | | 0.2 | | | | 0.45 | | | ⊙ | ⊙ | ⊙ | 107 | No crack |
| | 11 | | | | | 0.2 | | | | 0.45 | | | ◯ | ◯ | ◯ | 123 | No crack |
| | 12 | | | | | 0.2 | | | | 0.45 | | | ◯ | ◯ | ◯ | 123 | No crack |
| | 13 | | 0.075 | | | | | | | 0.6 | | | ⊙ | ◯ | ◯ | 135 | No crack |
| | 14 | | | | 0.2 | 0.2 | | | | | 0.25 | | ◯ | ◯ | ◯ | 140 | No crack |
| | 15 | | | | 0.2 | 0.2 | | | | | 0.095 | | ◯ | ◯ | ◯ | 150 | No crack |
| | 16 | | | | | 0.2 | | | | 0.45 | | | ◯ | ◯ | ◯ | 143 | No crack |
| | 17 | | | | | 0.2 | | | 0.1 | | | | ⊙ | ⊙ | ⊙ | 105 | No crack |
| | 18 | | | | | 0.2 | | | 0.1 | | | | ⊙ | ⊙ | ⊙ | 108 | No crack |
| | 19 | | | | | 0.2 | | | | 0.45 | | | ◯ | ◯ | ◯ | 150 | No crack |
| | 20 | | | | | 0.2 | | | | 0.45 | | | ◯ | ◯ | ◯ | 140 | No crack |
| | 21 | | | | | 0.2 | | | | 0.45 | | | ⊙ | ⊙ | ⊙ | 145 | No crack |
| | 22 | | | | | 0.2 | | | | 0.45 | | | ⊙ | ⊙ | ⊙ | 100 | No crack |
| | 23 | | | | | | 0.2 | | | 0.45 | | | Δ | ◯ | Δ | 184 | No crack |
| | 24 | | | | | | 0.5 | | | | | | ◯ | ◯ | ◯ | 170 | No crack |
| | 25 | | | | | | 0.2 | 0.25 | | | | | Δ | Δ | Δ | 250 | No crack |
| | 26 | | | | 0.2 | | 0.2 | | | | 0.17 | | Δ | Δ | ◯ | 171 | No crack |
| | 27 | | | 0.2 | | | | | | 0.45 | | | Δ | ◯ | Δ | 190 | No crack |
| | 28 | | | | 0.2 | | | | | 0.45 | | | Δ | ◯ | Δ | 200 | No crack |
| | 29 | | 0.2 | | | | | | | 0.45 | | | ⊙ | ◯ | ◯ | 171 | No crack |
| | 30 | | 0.2 | | | | | | | 0.45 | | | ⊙ | ◯ | ◯ | 185 | No crack |
| | 31 | | | | | 0.2 | | | | 0.45 | | | ⊙ | ⊙ | ⊙ | 149 | No crack |
| | 32 | | | | | 0.2 | | | | 0.45 | | | ⊙ | ⊙ | ⊙ | 131 | No crack |
| Com- | 1 | 0.25 | 0.2 | | | | | | | 0.45 | | | NG: | ◯ | NG: | 185 | No crack |
| parative | | | | | | | | | | | | | 1.5 mm | | 0.5 mm | | |
| Examples | 2 | 0.25 | 0.2 | | | | | | | 0.45 | | | NG: | ◯ | NG: | 185 | No crack |
| | | | | | | | | | | | | | 1.5 mm | | 0.5 mm | | |
| | 3 | | | | | | | | | | | 0.09 | NG: | ◯ | NG: | 240 | No crack |
| | | | | | | | | | | | | | 1 mm | | 0.6 mm | | |
| | 4 | | | | | 0.2 | | | | 0.45 | | | NG: | ◯ | ⊙ | 149 | No crack |
| | | | | | | | | | | | | | 2 mm | | | | |
| | 5 | 0.25 | 0.2 | | | | | | | 0.45 | | | NG: | ◯ | NG: | 185 | No crack |
| | | | | | | | | | | | | | 1.5 mm | | 1.5 mm | | |
| | 6 | 0.25 | 0.2 | | | | | | | 0.45 | | | NG: | ◯ | NG: | 185 | No crack |
| | | | | | | | | | | | | | 2 mm | | 2 mm | | |
| | 7 | | | | | 0.2 | | | | 0.45 | | | NG: | ◯ | ◯ | 171 | No crack |
| | | | | | | | | | | | | | 1 mm | | | | |
| | 8 | | | | | | | | | 0.45 | | | Δ | ◯ | Δ | 171 | Crack |
| | | | | | | | | | | | | | | | | | occurrence |
| Reference | 1 | 0.25 | 0.2 | | | | | | | 0.45 | | | ⊙ | ⊙ | ⊙ | 185 | No crack |
| Example | | | | | | | | | | | | | | | | | |

The materials shown in Table 1 are as follows.
MA: methyl acrylate
EA: ethyl acrylate
BA: n-butyl acrylate
MMA: methyl methacrylate
2EHA: 2-ethylhexyl acrylate
Biscoat 3F: 2,2,2-trifluoroethyl acrylate
BzA: benzyl acrylate
4HBA: 4-hydroxybutyl acrylate
HEA: 2-hydroxyethyl acrylate
NVP: N-vinyl pyrrolidone
AA: acrylic acid
MEA: methoxyethyl acrylate
SAT10: SILYL SAT10 manufactured by KANEKA CORPORATION
KBM403: KBM-403 manufactured by Shin-Etsu Chemical Co., Ltd.
KBM573: KBM-573 manufactured by Shin-Etsu Chemical Co., Ltd.
A100: A100 manufactured by Soken Chemical & Engineering Co., Ltd. (acetoacetyl group-containing silane coupling agent)
X-41-1810: oligomer mercapto group-containing silane coupling agent manufactured by Shin-Etsu Chemical Co., Ltd.
X-41-1056: oligomer epoxy group-containing silane coupling agent manufactured by Shin-Etsu Chemical Co., Ltd.
C/HX: isocyanate-based crosslinking agent (Coronate HX manufactured by Tosoh Corporation, isocyanurate form of hexamethylene diisocyanate)
TETRAD-C: epoxy-based crosslinking agent (TETRAD-C manufactured by MITSUBISHI GAS CHEMICAL COMPANY, INC./1,3-bis(N,N-glycidylaminomethyl)cyclohexane)
C/L: isocyanate-based crosslinking agent (Coronate L manufactured by Tosoh Corporation, trimethylolpropane tolylenediisocyanate)
D160N: isocyanate crosslinking agent (TAKENATE D160N manufactured by Mitsui Chemicals, Inc., trimethylolpropane hexamethylene diisocyanate)
HDDA: hexanediol diacrylate

### DESCRIPTION OF REFERENCE SIGNS

A Image display panel
1 Image display unit
2 Optical film (including polarizing film)
3 Pressure-sensitive adhesive layer (image display unit side)
4 Elastic intermediate layer
41 Holding part
42 Convex part
5 External bezel
6 Internal bezel
7 Vacancy
8 Pressure-sensitive adhesive layer (cover glass side)
9 Cover glass
S Space

1. A pressure-sensitive adhesive layer attached optical film, comprising an optical film and a pressure-sensitive adhesive layer, wherein
the optical film has a thickness of 75 μm or more,
the optical film comprises a one-side-protected polarizing film comprising a polarizer having a thickness of 10 μm or less and a transparent protective film (excluding a retardation film) on one surface of the polarizer, and the pressure-sensitive adhesive layer is provided on a side of the one-side-protected polarizing film on which the transparent protective film is not provided,
the pressure-sensitive adhesive layer is formed of a pressure-sensitive adhesive composition containing
a (meth)acrylic polymer (A) as a base polymer which contains 80 mass % or more of at least one kind of monomer (a) selected from among an alkyl (meth)acrylate having an alkyl group containing 1 to 4 carbon atoms, an alkoxyalkyl (meth)acrylate, a fluorine-containing monomer, and acrylonitrile as a monofunctional monomer unit and 20 mass % or more of n-butyl acrylate as a monofunctional monomer unit or 70 mass % or more of an alkoxyalkyl (meth)acrylate, and
a silane coupling agent (B),
the pressure-sensitive adhesive composition containing no polyether compound having a polyether skeleton and a reactive silyl group at at least one end of the compound.

2. The pressure-sensitive adhesive layer attached optical film according to claim 1, wherein the pressure-sensitive adhesive layer is provided on the one-side-protected polarizing film via retardation film.

3. The pressure-sensitive adhesive layer attached optical film according to claim 1, wherein the pressure-sensitive adhesive layer is directly provided on the polarizer of the one-side-protected polarizing film.

4. The pressure-sensitive adhesive layer attached optical film according to claim 1, wherein the optical film comprises a surface-treated layer on a viewing-side outermost surface thereof.

5. The pressure-sensitive adhesive layer attached optical film according to claim 1, wherein the optical film has a thickness of 300 μm or less.

6. The pressure-sensitive adhesive layer attached optical film according to claim 1, wherein the pressure-sensitive adhesive layer has a thickness of 10 to 30 μm.

7. The pressure-sensitive adhesive layer attached optical film according to claim 1, wherein the pressure-sensitive adhesive layer has a degree of swelling with oleic acid of more than 130% and 190% or less.

8. The pressure-sensitive adhesive layer attached optical film according to claim 1, wherein only the alkyl (meth)acrylate having an alkyl group of 1 to 4 carbon atoms is used as the monomer (a), and 30 mass % or more of n-butyl acrylate is contained as the monomer unit.

9. The pressure-sensitive adhesive layer attached optical film according to claim 8, wherein only n-butyl acrylate is used as the alkyl (meth)acrylate having an alkyl group of 1 to 4 carbon atoms, and 70 mass % or more of n-butyl acrylate is contained as the monomer unit.

10. The pressure-sensitive adhesive layer attached optical film according to claim 8, wherein the alkyl (meth)acrylate having an alkyl group of 1 to 4 carbon atoms contains an alkyl (meth)acrylate having an alkyl group of 1 to 4 carbon atoms (excluding n-butyl acrylate) and n-butyl acrylate.

11. The pressure-sensitive adhesive layer attached optical film according to claim 10, wherein 4 to 60 mass % of the alkyl (meth)acrylate having an alkyl group of 1 to 4 carbon atoms (excluding n-butyl acrylate) and 30 mass % or more of n-butyl acrylate are contained as the monomer unit.

12. The pressure-sensitive adhesive layer attached optical film according to claim 10, wherein 15 to 60 mass % of the alkyl acrylate having an alkyl group of 1 to 4 carbon atoms (excluding n-butyl acrylate) and 30 mass % or more of n-butyl acrylate are contained as the monomer unit.

13. The pressure-sensitive adhesive layer attached optical film according to claim 10, wherein 5 to 15 mass % of the alkyl methacrylate having an alkyl group of 1 to 4 carbon atoms and 70 mass % or more of n-butyl acrylate are contained as the monomer unit.

14. The pressure-sensitive adhesive layer attached optical film according to claim 1, wherein the monomer (a) contains the alkyl (meth)acrylate having an alkyl group of 1 to 4 carbon atoms and the fluorine-containing monomer, and 30 mass % or more of the alkyl (meth)acrylate having an alkyl group of 1 to 4 carbon atoms, 25 mass % or more of the fluorine-containing monomer, and 30 mass % or more of n-butyl acrylate are contained as the monomer unit.

15. The pressure-sensitive adhesive layer attached optical film according to claim 1, wherein the monomer (a) contains the alkyl (meth)acrylate having an alkyl group of 1 to 4 carbon atoms and acrylonitrile, and 70 mass % or more of the alkyl (meth)acrylate having an alkyl group of 1 to 4 carbon atoms, 5 mass % or more of acrylonitrile, and 70 mass % or more of n-butyl acrylate are contained as the monomer unit.

16. The pressure-sensitive adhesive layer attached optical film according to claim 1, wherein the monomer (a) contains 70 mass % or more of the alkoxyalkyl (meth)acrylate.

17. The pressure-sensitive adhesive layer attached optical film according to claim 1, wherein the silane coupling agent (B) is at least one selected from among an epoxy group-containing silane coupling agent (b1) and a mercapto group-containing silane coupling agent (b2).

18. The pressure-sensitive adhesive layer attached optical film according to claim 17, wherein the epoxy group-containing silane coupling agent (b1) is a low molecular-weight epoxy group-containing silane coupling agent (b1).

19. The pressure-sensitive adhesive layer attached optical film according to claim 17, wherein the mercapto group-containing silane coupling agent (b2) is an oligomer mercapto group-containing silane coupling agent (b2).

20. The pressure-sensitive adhesive layer attached optical film according to claim 1, wherein the pressure-sensitive adhesive composition contains a crosslinking agent.

21. An image display panel comprising an image display unit and the pressure-sensitive adhesive layer attached optical film according to claim 1.

22. The image display panel according to claim 21, wherein the pressure-sensitive adhesive layer attached optical film is provided on a viewing side of the image display unit via the pressure-sensitive adhesive layer of the pressure-sensitive adhesive layer attached optical film.

23. An image display device comprising the image display panel according to claim 21.
